(19) United States
(12) Patent Application Publication
(10) Pub. No.: US 2026/0101231 A1
(43) Pub. Date: Apr. 9, 2026

(54) ASSISTANCE OPERATION METHOD AND APPARATUS

(71) Applicant: BEIJING XIAOMI MOBILE SOFTWARE CO., LTD., Beijing (CN)

(72) Inventors: Jinhua WU, Beijing (CN); Yang SHEN, Beijing (CN); Deqian WANG, Beijing (CN); Jianfeng QI, Beijing (CN)

(21) Appl. No.: 19/114,372

(22) PCT Filed: Sep. 26, 2022
(86) PCT No.: PCT/CN2022/121513

§ 371 Date: Mar. 21, 2025

(51) Int. Cl. H04W 28/02; H04W 8/24

(52) U.S. Cl. CPC H04W 28/0268; H04W 8/24

(57) ABSTRACT

An assistance operation method and device are used in a wireless communication network. A terminal generates terminal status assistance operation information according to status information of the terminal, and sends the terminal status assistance operation information to a core network through an access network device.

### CROSS-REFERENCE TO RELATED APPLICATION

This application is the US national phase application of International Application No. PCT/CN2022/121513, filed on Sep. 26, 2022, the entire contents of which are incorporated herein by reference for all purposes.

### TECHNICAL FIELD

The disclosure relates to the field of wireless communication technologies, and in particular, to an assistance operation method and device.

### BACKGROUND

Mobile media services, XR (extended reality) services such as cloud AR (augmented reality)/VR (virtual reality), cloud gaming, video based remote control of machines or drones and other types of services are expected to contribute increasingly high traffic to 5G wireless communication networks. In addition to audio and video streaming, XR services also involve multimodal data streams, such as data streams for biological tactile perception. These multimodal data streams include data input from the same device or different devices (including sensors) for the same business or application, which may be output to one or more destination terminals. The various data streams in multimodal data often have correlations, such as the synchronization of audio and video streams, and the synchronization of touch and vision.

### SUMMARY

In a first aspect, embodiments of the present disclosure provide an assistance operation method, performed by a terminal, including: generating terminal status assistance operation information according to status information of the terminal; and sending the terminal status assistance operation information to a core network through an access network device.

In a second aspect, embodiments of the present disclosure provide another assistance operation method, performed by an SMF, including: receiving terminal status assistance operation information; and sending the terminal status assistance operation information to a PCF.

In a third aspect, embodiments of the present disclosure provide yet another assistance operation method, performed by a PCF, including: receiving terminal status assistance operation information sent by an SMF; and generating a policy and charging control (PCC) rule according to the terminal status assistance operation information.

In a fourth aspect, embodiments of the present disclosure provide still yet another assistance operation method, performed by a core network, including: receiving terminal status assistance operation information; and generating a policy related rule according to the terminal status assistance operation information.

In a fifth aspect, embodiments of the present disclosure provide a communication device. The communication device has some or all of the functions of the terminal in implementing the method described in the first aspect. For example, the communication device may have the functions in some or all of embodiments of the present disclosure, or may have the function of independently implementing any of the embodiments in this disclosure. The functions can be implemented through hardware or by executing corresponding software through hardware. The hardware or software includes one or more units or modules corresponding to the above functions.

The communication device includes: a processing module, configured to generate terminal status assistance operation information according to status information of the terminal; a transceiver module, configured to send the terminal status assistance operation information to a core network through an access network device.

In a sixth aspect, embodiments of the present disclosure provide another communication device. The communication device has some or all of the functions of the SMF in implementing the method described in the second aspect. For example, the communication device may have the functions in some or all of embodiments of the present disclosure, or may have the function of independently implementing any of the embodiments in this disclosure. The functions can be implemented through hardware or by executing corresponding software through hardware. The hardware or software includes one or more units or modules corresponding to the above functions.

The communication device includes a transceiver module, configured to receive terminal status assistance operation information; the transceiver module is further configured to send the terminal status assistance operation information to a PCF.

In a seventh aspect, embodiments of the present disclosure provide another communication device. The communication device has some or all of the functions of the PCF in implementing the method described in the third aspect. For example, the communication device may have the functions in some or all of embodiments of the present disclosure, or may have the function of independently implementing any of the embodiments in this disclosure. The functions can be implemented through hardware or by executing corresponding software through hardware. The hardware or software includes one or more units or modules corresponding to the above functions.

The communication device includes: a transceiver module, configured to receive terminal status assistance operation information sent by an SMF; a processing module, configured to generate a PCC rule according to the terminal status assistance operation information.

In an eighth aspect, embodiments of the present disclosure provide a communication device. The communication device includes a processor that executes the method described in the first aspect when the processor calls a computer program stored in a memory.

In a nineth aspect, embodiments of the present disclosure provide a communication device. The communication device includes a processor that executes the method described in the second aspect when the processor calls a computer program stored in a memory.

In a tenth aspect, embodiments of the present disclosure provide a communication device. The communication device includes a processor that executes the method described in the third aspect when the processor calls a computer program stored in a memory.

In an eleventh aspect, embodiments of the present disclosure provide a communication device. The communication device includes a processor that executes the method described in the fourth aspect when the processor calls a computer program stored in a memory.

In a twelfth aspect, embodiments of the present disclosure provide a communication device. The communication device includes a processor and a memory, wherein the memory stores a computer program; the processor executes the computer program stored in the memory to enable the communication device to perform the method described in the first aspect above.

In a thirteenth aspect, embodiments of the present disclosure provide a communication device. The communication device includes a processor and a memory, wherein the memory stores a computer program; the processor executes the computer program stored in the memory to enable the communication device to perform the method described in the second aspect above.

In a fourteenth aspect, embodiments of the present disclosure provide a communication device. The communication device includes a processor and a memory, wherein the memory stores a computer program; the processor executes the computer program stored in the memory to enable the communication device to perform the method described in the third aspect above.

In a fifteenth aspect, embodiments of the present disclosure provide a communication device. The communication device includes a processor and a memory, wherein the memory stores a computer program; the processor executes the computer program stored in the memory to enable the communication device to perform the method described in the fourth aspect above.

In a sixteenth aspect, embodiments of the present disclosure provide a communication device. The device includes a processor and an interface circuit, wherein the interface circuit is configured to receive code instructions and transmit them to the processor, and the processor is configured to run the code instructions to cause the device to perform the method described in the first aspect above.

In a seventeenth aspect, embodiments of the present disclosure provide a communication device. The device includes a processor and an interface circuit, wherein the interface circuit is configured to receive code instructions and transmit them to the processor, and the processor is configured to run the code instructions to cause the device to perform the method described in the second aspect above.

In an eighteenth aspect, embodiments of the present disclosure provide a communication device. The device includes a processor and an interface circuit, wherein the interface circuit is configured to receive code instructions and transmit them to the processor, and the processor is configured to run the code instructions to cause the device to perform the method described in the third aspect above.

In a nineteenth aspect, embodiments of the present disclosure provide a communication device. The device includes a processor and an interface circuit, wherein the interface circuit is configured to receive code instructions and transmit them to the processor, and the processor is configured to run the code instructions to cause the device to perform the method described in the fourth aspect above.

In a twentieth aspect, embodiments of the present disclosure provide a communication system. The system includes a communication device as described in the fifth aspect, a communication device as described in the sixth aspect, and a communication device as described in the seventh aspect. Alternatively, the system includes a communication device as described in the eighth aspect, a communication device as described in the ninth aspect, a communication device as described in the tenth aspect, and a communication device as described in the eleventh aspect. Alternatively, the system includes a communication device as described in the twelfth aspect, a communication device as described in the thirteenth aspect, a communication device as described in the fourteenth aspect, and a communication device as described in the fifteenth aspect. Alternatively, the system includes a communication device as described in the sixteenth aspect, a communication device as described in the seventeenth aspect, a communication device as described in the eighteenth aspect, and a communication device as described in the nineteenth aspect.

In a twenty-first aspect, embodiments of the present disclosure provide a computer readable storage medium, configured to store instructions used for the terminal described above, which when executed, cause the terminal to implement the method described in the first aspect above.

In a twenty-second aspect, embodiments of the present disclosure provide a readable storage medium, configured to store instructions used for the SMF described above, which when executed, cause the SMF to implement the method described in the second aspect above.

In a twenty-third aspect, embodiments of the present disclosure provide a readable storage medium, configured to store instructions used for the PCF described above, which when executed, cause the PCF to implement the method described in the third aspect above.

In a twenty-fourth aspect, embodiments of the present disclosure provide a readable storage medium, configured to store instructions used for the core network described above, which when executed, cause the core network to implement the method described in the fourth aspect above.

In a twenty-fifth aspect, embodiments of the present disclosure provide a computer program product including a computer program that, when run on a computer, causes the computer to perform the method described in the first aspect.

In a twenty-sixth aspect, embodiments of the present disclosure provide a computer program product including a computer program that, when run on a computer, causes the computer to perform the method described in the second aspect.

In a twenty-seventh aspect, embodiments of the present disclosure provide a computer program product including a computer program that, when run on a computer, causes the computer to perform the method described in the third aspect.

In a twenty-eighth aspect, embodiments of the present disclosure provide a computer program product including a computer program that, when run on a computer, causes the computer to perform the method described in the fourth aspect.

In a twenty-nineth aspect, embodiments of the present disclosure provide a chip system. The chip system includes at least one processor and interface for supporting the terminal to implement the functions involved in the first aspect, such as determining or processing at least one of data and information involved in the above methods. In a possible design, the chip system further includes a memory for storing necessary computer programs and data for the terminal. This chip system can be composed of chips or include chips and other discrete components.

In a thirtieth aspect, embodiments of the present disclosure provide a chip system. The chip system includes at least one processor and interface for supporting the SMF to implement the functions involved in the second aspect, such as determining or processing at least one of data and information involved in the above methods. In a possible design, the chip system further includes a memory for storing necessary computer programs and data for the SMF. This chip system can be composed of chips or include chips and other discrete components.

In a thirty-first aspect, embodiments of the present disclosure provide a chip system. The chip system includes at least one processor and interface for supporting the PCF to implement the functions involved in the third aspect, such as determining or processing at least one of data and information involved in the above methods. In a possible design, the chip system further includes a memory for storing necessary computer programs and data for the PCF. This chip system can be composed of chips or include chips and other discrete components.

In a thirty-second aspect, embodiments of the present disclosure provide a chip system. The chip system includes at least one processor and interface for supporting the core network to implement the functions involved in the fourth aspect, such as determining or processing at least one of data and information involved in the above methods. In a possible design, the chip system further includes a memory for storing necessary computer programs and data for the core network. This chip system can be composed of chips or include chips and other discrete components.

In a thirty-third aspect, embodiments of the present disclosure provide a computer program that, when executed on a computer, causes the computer to perform the method described in the first aspect.

In a thirty-fourth aspect, embodiments of the present disclosure provide a computer program that, when executed on a computer, causes the computer to perform the method described in the second aspect.

In a thirty-fifth aspect, embodiments of the present disclosure provide a computer program that, when executed on a computer, causes the computer to perform the method described in the third aspect.

In a thirty-sixth aspect, embodiments of the present disclosure provide a computer program that, when executed on a computer, causes the computer to perform the method described in the fourth aspect.

### BRIEF DESCRIPTION OF THE DRAWINGS

In order to provide a clearer explanation of the technical solution in embodiments of the present disclosure or background technology, the accompanying drawings required for use in embodiments of the present disclosure or background technology will be described below.

FIG. 1 is a schematic diagram of an architecture of a communication system provided in an embodiment of the present disclosure.

FIG. 2 is a flowchart of an assistance operation method provided in an embodiment of the present disclosure.

FIG. 3 is a flowchart of another assistance operation method provided in an embodiment of the present disclosure.

FIG. 4 is a flowchart of yet another assistance operation method provided in an embodiment of the present disclosure.

FIG. 5 is a flowchart of a PDU session establishment method provided in an embodiment of the present disclosure.

FIG. 6 is a flowchart of yet another assistance operation method provided in an embodiment of the present disclosure.

FIG. 7 is a flowchart of yet another assistance operation method provided in an embodiment of the present disclosure.

FIG. 8 is a flowchart of yet another assistance operation method provided in an embodiment of the present disclosure.

FIG. 9 is a flowchart of yet another assistance operation method provided in an embodiment of the present disclosure.

FIG. 10 is a block diagram of a core network provided in an embodiment of the present disclosure.

FIG. 11 is a block diagram of a communication device provided in an embodiment of the present disclosure.

FIG. 12 is a block diagram of another communication device provided in an embodiment of the present disclosure.

FIG. 13 is a block diagram of a chip provided in an embodiment of the present disclosure.

### DETAILED DESCRIPTION

In order to better understand the assistance operation method and device disclosed in embodiments of the present disclosure, the following first describes the communication system applicable to embodiments of the present disclosure.

The exemplary embodiments will be described in detail here, with examples shown in the accompanying drawings. When referring to the accompanying drawings, unless otherwise indicated, the same numbers in different drawings represent the same or similar elements. The implementations described in the following exemplary embodiments do not represent all implementations consistent with the embodiments of the present disclosure. On the contrary, they are only examples of devices and methods consistent with some aspects of the embodiments of the present disclosure as described in the accompanying claims.

The terms used in embodiments of the present disclosure are only for the purpose of describing specific embodiments and are not intended to limit the embodiments of the present disclosure. The singular forms of “a” and “the” used in this disclosure and the accompanying claims are also intended to include the majority form, unless the context clearly indicates otherwise. It should also be understood that the term “and/or” used in this article refers to and includes any or all possible combinations of one or more associated listed items.

It should be understood that although various information may be described using terms such as first, second, third, etc. in this disclosure, such information should not be limited to these terms. These terms are only used to distinguish information for the same type from each other. For example, without departing from the scope of this disclosure, the first information can also be referred to as the second information, and similarly, the second information can also be referred to as the first information. Depending on the context, the word “if” used here can be interpreted as “when . . . ” or “in a case where . . . ” or “in response to determining . . . ”.

It should be noted that the information (including but not limited to user device information, user personal information, etc.), data (including but not limited to data used for analysis, stored data, displayed data, etc.), and signals involved in this disclosure are all authorized by the user or fully authorized by all parties, and the collection, use, and processing of relevant data must comply with relevant laws, regulations, and standards of relevant countries and regions.

It should be understood that the technical solutions of various embodiments disclosed herein can be applied to various communication systems according to access standards, such as Global System of Mobile Communication (GSM) systems, Code Division Multiple Access (CDMA) systems, Wideband Code Division Multiple Access Wireless (WCDMA) systems, General Packet Radio Service (GPRS) systems, Long Term Evolution (LTE) systems, LTE Frequency Division Duplex (FDD) systems, LTE Time Division Duplex (TDD) systems, Universal Mobile Telecommunication System (UMTS), wireless cellular network systems, 5G systems and future communication systems.

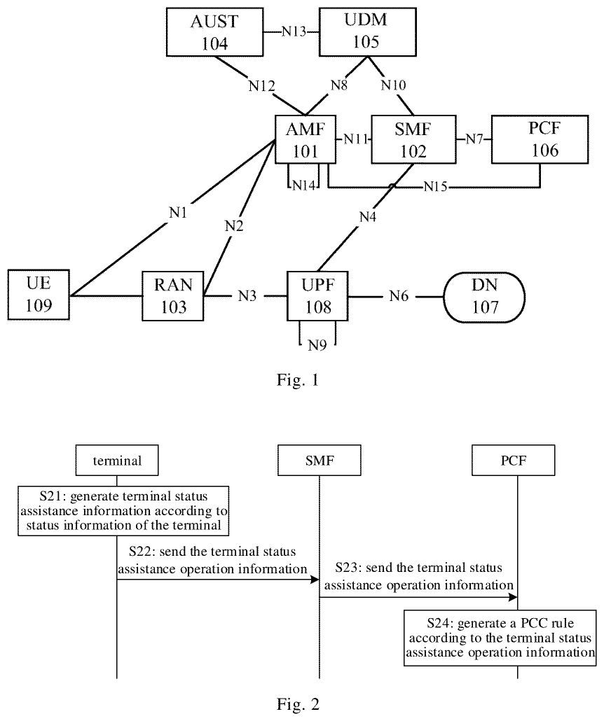

FIG. 1 shows a schematic diagram of a communication system 10 using an assistance operation method disclosed herein. As shown in FIG. 1, the communication system 10 mainly includes AMF 101, Session Management Function (SMF) 102, Radio Access Network (RAN) 103, Authentication Server Function (AUSF) 104, Unified Data Management (UDM) 105, Policy Control Function (PCF) 106, Data Network (DN) 107, User Plane Function (UPF) 108, and User Equipment (UE) 109. UE 109 is connected to AMF 101 through the N1 interface, and UE 109 is connected to RAN 103 through the Radio Resource Control (RRC) protocol; RAN 103 is connected to AMF 101 through N2 interface, and RAN 103 is connected to UPF 108 through N3 interface; Multiple UPFs 108 are connected through the N9 interface, while UPFs 108 are connected to DN 107 through the N6 interface. Additionally, UPFs 108 are connected to SMF 102 through the N4 interface; SMF 102 is connected to PCF 106 through the N7 interface, to UDM 105 through the N10 interface, and to AMF 101 through the N11 interface; Multiple AMFs 101 are connected through the N14 interface, AMF 101 is connected to UDM 105 through the N8 interface, AMF 101 is connected to AUSF 104 through the N12 interface, and AMF 101 is connected to PCF 106 through the N15 interface; AUSF 104 is connected to UDM 105 through the N13 interface. AMF 101 and SMF 102 respectively obtain user subscription data from UDM 105 through N8 and N10 interfaces, and policy data from PCF 106 through N15 and N7 interfaces. SMF 102 controls UPF 108 through the N4 interface.

Access and Mobility Management Function (AMF) 101 is mainly used for mobility management and access management, and can be used to implement other functions of the Mobility Management Entity (MME) besides session management, such as lawful listening and access authorization/authentication. It can be understood that, hereinafter referred to as AMF network function is AMF. In an embodiment of the present disclosure, AMF may include initial AMF, old AMF, and target AMF. For example, the initial AMF can be understood as the first AMF to process the UE registration request in this registration. The initial AMF is selected by the (R)AN, but it may not necessarily serve the UE. The old AMF can be understood as the AMF that served the UE when the UE last registered to the network, and the target AMF can be understood as the AMF that serves the UE after the UE re-registers.

SMF 102 is used for session management (such as session establishment, modification, and release), selection and control of UPF 12, selection of service and session continuity modes, and roaming services.

(Radio) Access Network ((R)AN) 103 is used to provide network access function for authorized terminals in specific areas, and can use transmission tunnels with different qualities according to the level of terminals, business requirements, etc. (R)AN can manage radio resources, provide access services for terminals, and thereby complete the forwarding of control information and/or data information between terminals and the core network (CN). The access network device in embodiments of the present disclosure is a device that provides wireless communication functionality for terminals, also known as a network device. The access network device may include: next generation node base station (gNB) in 5G system, evolved node B (eNB) in Long Term Evolution (LTE), radio network controller (RNC), node B (NB), base station controller (BSC), base transceiver station (BTS), home base station (e.g. home evolved node B, or home node B, HNB), Base band unit (BBU), transmitting and receiving point (TRP), transmitting point (TP), small base station equipment (Pico), mobile switching center, or network device in future networks. It can be understood that the specific type of the access network device is not limited in embodiments of the present disclosure. The names of devices with access network functionality may vary in systems with different wireless access technologies.

AUSF 104 is used to interact with UDM 20 to obtain user information, and perform authentication related functions, such as generating intermediate keys.

UDM 105 is used for handling authentication information in 3GPP authentication and key negotiation mechanisms, handling user identity information, access authorization, registration and mobility management, subscription management, short message management, etc.

PCF 106 is used for formulating strategies, providing strategy control services, and obtaining subscription information related to strategy decisions.

DN 107 refers to a network that provides data transmission services for users, such as IMS (IP Multimedia Service), the Internet, etc. There can be multiple application servers in DN.

UPF 108 is used to handle events related to the user plane, such as transmitting or routing data packets, detecting data packets, reporting traffic, handling quality of service (QoS), lawful listening, storing downlink data packets, etc.

UE 109 (user equipment) is an entity on the user side used for receiving or transmitting signals, such as a mobile phone. The terminal can also be referred to as terminal device, user device, mobile station (MS), mobile terminal (MT), etc. The terminal can be a communication enabled car, smart car, mobile phone, wearable device, tablet, computer with wireless transmission and reception capabilities, virtual reality (VR) terminal, augmented reality (AR) terminal, wireless terminal in industrial control, wireless terminal in autonomous driving, wireless terminal in remote medical surgery, wireless terminal in smart grids, wireless terminal in transportation safety, wireless terminal in smart city, wireless terminal in smart home, etc. The specific technology and device form adopted by the terminal are not limited in embodiments of the present disclosure.

In this network architecture, the N1 interface is the interface between the terminal and AMF. The N2 interface is the interface between RAN and AMF, used for sending non access stratum (NAS) messages, etc. The N3 interface is the interface between (R)AN and UPF, used for transmitting user plane data, etc. The N4 interface is the interface between SMF and UPF, used for transmitting tunnel identification information such as N3 connection, data cache indication information, and downlink data notification messages. The N6 interface is the interface between UPF and DN, used for transmitting user plane data, etc.

It can be understood that the terms introduced above may have different names in different fields or standards, so the names shown above should not be understood as limiting embodiments of the present disclosure. The above network functions or functionalities can be network elements in hardware devices, software functions running on dedicated hardware, or virtualization functions instantiated on platforms (such as cloud platforms).

It should be noted that the network elements involved in embodiments of the present disclosure can also be referred to as functional devices or functions or entities or functional entities. For example, access and mobility management network elements can also be referred to as access and mobility management functional devices or access and mobility management functional entities or access and mobility management functional entities. The names of various functional devices are not limited in this disclosure, and those skilled in the art may replace the names of the above-mentioned functional devices with other names to perform the same functions, all of which are within the scope of protection of this disclosure. The above-mentioned functional devices can be network elements in hardware devices, software functions running on dedicated hardware, or virtualization functions instantiated on platforms (such as cloud platforms).

It can be understood that the communication system and network architecture described in this disclosure are intended to provide a clearer explanation of the technical solution of this disclosure, and do not constitute a limitation on the technical solution provided in this disclosure. Those skilled in the art will know that with the evolution of system architecture and the emergence of new business scenarios, the technical solution provided in this disclosure is also applicable to similar technical problems.

In the following, the assistance operation method and device provided in this disclosure will be described in detail with reference to the accompanying drawings.

In the related art, mobile media services, XR (extended reality) services such as cloud AR (augmented reality)/VR (virtual reality), cloud gaming, video based remote control of machines or drones and the like are expected to contribute increasingly high traffic to 5G networks. In addition to audio and video streaming, XR services also involve multimodal data streams, such as data streams for biological tactile perception. These multimodal data describe data input from the same device or different devices (including sensors) for the same business or application, which may be output to one or more destination terminals. The various data streams in multimodal data often have correlations, such as the synchronization of audio and video streams, and the synchronization of touch and vision. The data streams of this type of media business themselves, various data streams, and the network transmission requirements of these business data streams all have some common characteristics. The effective identification and utilization of these characteristics will be more helpful for the transmission and control of networks and businesses, as well as for business security and user experience.

However, the 5GS system adopts a universal QoS mechanism to handle various data services, including XR services, without fully considering the characteristics of XR media services, and cannot effectively support differentiated uplink and downlink requirements, such as asymmetric requirements for uplink data reliability and downlink data bandwidth. Meanwhile, XR media data streams have the characteristics of high bandwidth, low latency, and high reliability requirements, resulting in significant energy consumption. The energy consumption plan is also an important factor affecting business usage and user experience.

An objective has been defined for the 3GPP Study on XR and media services which is related with UE power management:
WT #4: Study potential enhancements of power management considering traffic pattern of media services:
WT 4.1: Void.
WT 4.2: Power saving enhancement e.g. support trade-off of throughput/latency/reliability considering device battery life, whether and how to enhance CDRX, considering XR/media traffic pattern.

And a Key issue has been defined for the 3GPP Study on XRM service:

The more efficient codec requires more power consumption and higher reliability. Also, the higher throughput and lower latency budget also requires more power consumption and more network resource. Hence, trade-off of QoS and device power consumption needs to be considered.

### This Key Issue Aims at Addressing the Following Points for XRM:

How to support trade-off of throughput/latency/reliability and power consumption (e.g. device battery life).

There is currently no corresponding QoS and policy mechanism in the related art to meet the above series of corresponding requirements.

In particular, to support the transmission of XR media services and multimodal data streams, potential enhancements to energy management considering the traffic characteristics of XR media services are being studied, for example, supporting tradeoff of throughput, latency, reliability, and other factors that considers device UE status information (such as device temperature, battery life, power mode, CPU load, etc., e.g. overheating/heating level, battery level, CPU load). At present, the 5GS system does not support such requirements and there is no corresponding technical solution.

In the related art, there are certain local energy-saving solutions for UE, but there is still a lack of methods for implementing PCC policy formulation and QoS authorization, as well as dynamically adjusting business data flow authorization based on different UE status information (such as UE battery level, UE battery life, power supply mode (including battery-powered or mains/wall-powered), UE overheating status, etc.), combined with corresponding business characteristics.

In the related art, it has never been considered to reduce the QoS level of certain specific services based on UE status information (such as UE battery level, UE battery life, power supply mode (including battery-powered or mains/wall-powered), UE overheating status, etc.). (Based on existing UE implementation, multiple schemes may be applied on UE locally based on battery level. However, the reduction of QoS levels of some specific service based on the UE status information (e.g. UE battery level, UE battery life, Powered mode including battery-powered or mains/wall-powered, UE overheating status) has never been considered.)

Therefore, how to provide the detailed mechanism of “UE status assistance operation indication/information” (such as UE battery level, UE battery life, power supply mode (including battery-powered or mains/wall-powered), UE overheating status) to the network, and make the policy determination and enforcement based on the “UE status assistance operation indication/information” to support the trade-off of throughput/latency/reliability and power consumption, is an urgent problem to be solved.

Although the terminal can report directly, considering that most of the UE status information belongs to internal information, there is a certain risk in disclosing the internal information of the terminal to the network.

In the related art, a universal QoS (quality of service) mechanism is used to handle various data services, including XR services. However, the characteristics of XR services have not been fully considered. The data streams of XR services have high bandwidth, low latency, and high reliability requirements, and energy consumption issues are prominent. Therefore, it is urgent to enhance energy management based on the characteristics of XR services.

Based on this, embodiments of the present disclosure provide an assistance operation method, in which the terminal can generate terminal status assistance operation information based on the status information of the terminal, and report the terminal status assistance operation information to the network, avoiding the terminal disclosing internal information to the network, and can also report the terminal status assistance operation information generated based on the status information of the terminal to the network to assist the network in making policy decisions, which helps to generate a PCC rule that better matches the business and terminal status, thereby saving energy consumption of the terminal.

In addition, for the convenience of understanding embodiments of the present disclosure, the following explanations are made.

Firstly, in embodiments of the present disclosure, “indicate” may include both directly indicate and indirectly indicate. When describing a certain information used to indicate A, it may include the information directly indicating A or indirectly indicating A, but it does not necessarily mean that A is carried in the information.

The information indicated by information is referred to as the information to be indicated. There are many ways to indicate the information to be indicated in the specific implementation process, such as but not limited to directly indicating the information to be indicated, such as the information itself or the index of the information to be indicated. It is also possible to indirectly indicate the information to be indicated by indicating other information, where there is a correlation between the other information and the information to be indicated. It is also possible to indicate only a part of the information to be indicated, while the other parts of the information to be indicated are known or pre agreed upon. For example, it is also possible to use the pre agreed (such as protocol specified) arrangement order of various information to achieve the indication of specific information, thereby reducing the indication overhead to a certain extent.

The information to be indicated can be sent together as a whole or divided into multiple sub information to be sent separately, and the sending period and/or timing of these sub information can be the same or different. The specific sending method is not limited in this disclosure. The sending period and/or timing of these sub information can be pre-defined, such as according to the protocol.

Secondly, the “protocol” referred to in embodiments of the present disclosure may refer to a standard protocol in the field of communication, such as LTE protocol, NR protocol, and related protocols applied in future communication systems, which is not limited in this disclosure.

Thirdly, the term “save” referred to in embodiments of the present disclosure may refer to being stored in one or more memories. The one or more memories may be separately configured or integrated into an encoder or decoder, processor, or communication device. The one or more memories may also be partially separately configured and partially integrated into a decoder, processor, or communication device. The type of memory can be any form of storage medium, which is not limited in this disclosure.

Fourthly, embodiments of the present disclosure list multiple implementations to clearly illustrate the technical solution of embodiments of the present disclosure. Of course, those skilled in the art can understand that the multiple embodiments provided in this disclosure can be executed separately, combined with the methods of other embodiments in this disclosure, or executed separately or in combination with some methods in other related technologies, which is not limited in embodiments of the present disclosure.

Please refer to FIG. 2, which is a flowchart of an assistance operation method provided in an embodiment of the present disclosure. As shown in FIG. 2, the method may include but is not limited to the following steps.
S21, a terminal generates terminal status assistance operation information according to status information of the terminal.

In an embodiment of the present disclosure, the terminal can generate the terminal status assistance operation information according to the status information of the terminal.

The terminal can generate the terminal status assistance operation information based on implementation, access network device indication, or protocol agreement.

In a possible implementation, after receiving a policy related rule (such as a PCC rules (assistance operation rule)), the terminal generates the terminal status assistance operation information, combined with the status information of the terminal.

It can be understood that the terminal can receive the policy related rule (such as the PCC rule (assistance operation rule)) sent by a PCF (sent by the PCF through any other network element, such as AMF, SMF).

In an embodiment of the present disclosure, the terminal status assistance operation information generated by the terminal according to the status information of the terminal may be used to indicate related information of the policy related rule that the terminal needs to obtain.

In some embodiments, the status information of the terminal includes at least one of:
a battery level;
a battery life;
a powered mode;
an overheating status;
a load status.

In an embodiment of the present disclosure, generating the terminal status assistance operation information by the terminal according to the status information of the terminal may be generating the terminal status assistance operation information according to the battery level of the terminal.

In an embodiment of the present disclosure, generating the terminal status assistance operation information by the terminal according to the status information of the terminal may be generating the terminal status assistance operation information according to the battery life of the terminal.

In an embodiment of the present disclosure, generating the terminal status assistance operation information by the terminal according to the status information of the terminal may be generating the terminal status assistance operation information according to the powered mode of the terminal.

The powered mode of the terminal may include battery-powered, or mains-powered, or wall-powered.

In an embodiment of the present disclosure, generating the terminal status assistance operation information by the terminal according to the status information of the terminal may be generating the terminal status assistance operation information according to the overheating status of the terminal.

In an embodiment of the present disclosure, generating the terminal status assistance operation information by the terminal according to the status information of the terminal may be generating the terminal status assistance operation information according to the load status of the terminal.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In some embodiments, the terminal status assistance operation information includes at least one of:
a terminal status assistance operation indication;
terminal status assistance operation demand information;
terminal status assistance operation policy information.

In an embodiment of the present disclosure, generating the terminal status assistance operation information by the terminal according to the status information of the terminal may be generating the terminal status assistance operation indication.

In an embodiment of the present disclosure, generating the terminal status assistance operation information by the terminal according to the status information of the terminal may be generating the terminal status assistance operation demand information.

It can be understood that the generated terminal status assistance operation demand information can include the policy related rule that the terminal device expects the network to configure to meet its terminal status assistance operation demand information.

In an embodiment of the present disclosure, generating the terminal status assistance operation information by the terminal according to the status information of the terminal may be generating the terminal status assistance operation policy information.

It can be understood that the generated terminal status assistance operation policy information may be information of assistance operation policies that the terminal expects the network to configure.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In an embodiment of the present disclosure, the terminal generates the terminal status assistance operation information based on the status information of the terminal. The terminal status assistance operation information can be used to indicate the information shown in Table 1 below:

| Information | | | |
|---|---|---|---|
| name | Description | Category | Scope |
| UE status | Identifies the UE status | Mandatory | PDU context |
| Assistance | Assistance Operation mode | | |
| Operation | that should be applied for | | |
| Mode | the matching traffic and | | |
| | associated parameters. | | |
| UE status | Indicates either | Optional | PDU context |
| Assistance | autonomous operation or | | |
| Operation | UE-assistance operation if | | |
| Mode | UE status Assistance | | |
| Indicator | Operation mode is set to | | |
| | e.g. “Load Balancing”/ | | |
| | “power consumption”/ | | |
| | “PDU set based QoS | | |
| | handling”. | | |
| Threshold | A Maximum RTT and/or a | Optional | PDU context |
| Values | Maximum Packet Loss | | |
| | Rate, and/or | | |
| | GFBR/AMBR; | | |
| UE status | Identifies whether the | Optional | PDU context |
| Assistance | “Load Balancing” | | |
| Operation | functionality / “power | | |
| Functionality | consumption” functionality / | | |
| | “PDU set based QoS | | |
| | handling” functionality | | |
| | should be applied for the | | |
| | matching traffic. | | |
| priority/ | Identifies whether the QoS | Optional | PDU context |
| importance | should be applied the high | | |
| | priority/importance level | | |
| | for the matching traffic. | | |

It can be understood that each element in Table 1 exists independently and is listed in the same table as an example, but it does not mean that all elements in the table must exist simultaneously as shown in the table. The value of each element is independent of any other element values in Table 1. Therefore, technicians in this field can understand that the value of each element in Table 1 is an independent embodiment.

In some embodiments, the terminal status assistance operation information is configured to indicate at least one of:
an assistance operation mode;
an operation indicator corresponding to the assistance operation mode;
a threshold value;
an assistance operation mode functionality;
a priority; or
an importance.

In an embodiment of the present disclosure, the terminal generates the terminal status assistance operation information according to the status information of the terminal, and the terminal status assistance operation information may be configured to indicate the assistance operation mode.

In an embodiment of the present disclosure, the terminal generates the terminal status assistance operation information according to the status information of the terminal, and the terminal status assistance operation information may be configured to indicate the operation indicator corresponding to the assistance operation mode.

In an embodiment of the present disclosure, the terminal generates the terminal status assistance operation information according to the status information of the terminal, and the terminal status assistance operation information may be configured to indicate the threshold value.

In an embodiment of the present disclosure, the terminal generates the terminal status assistance operation information according to the status information of the terminal, and the terminal status assistance operation information may be configured to indicate the assistance operation mode functionality.

In an embodiment of the present disclosure, the terminal generates the terminal status assistance operation information according to the status information of the terminal, and the terminal status assistance operation information may be configured to indicate the priority.

In an embodiment of the present disclosure, the terminal generates the terminal status assistance operation information according to the status information of the terminal, and the terminal status assistance operation information may be configured to indicate the importance.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In some embodiments, the assistance operation mode is configured to indicate the assistance operation mode can be applied to matching traffic and associated parameters.

In an embodiment of the present disclosure, the terminal generates the terminal status assistance operation information according to the status information of the terminal, and the terminal status assistance operation information may be configured to indicate the assistance operation mode, wherein the assistance operation mode is configured to indicate the assistance operation mode can be applied to matching traffic and associated parameters.

It should be noted that the assistance operation mode can also be configured to indicate the assistance operation mode can be applied to one or more of matching data packets, data packet sets, PDU sets, QoS flows, PDU sessions, UE slices, UE, all UEs in an XRM service group.

In some embodiments, the operation indicator corresponding to the assistance operation mode includes at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to PDU set based QoS handling; or
indicating terminal-assistance operation in a case where the assistance operation mode is set to PDU set based QoS handling.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating autonomous operation in a case where the assistance operation mode is set to load balancing.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating terminal-assistance operation in a case where the assistance operation mode is set to load balancing.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating autonomous operation in a case where the assistance operation mode is set to power consumption.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating terminal-assistance operation in a case where the assistance operation mode is set to power consumption.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating autonomous operation in a case where the assistance operation mode is set to PDU (protocol data unit) set based QoS handling.

In an embodiment of the present disclosure, the terminal generates the terminal status assistance operation information according to the status information of the terminal, and the terminal status assistance operation information may be configured to indicate the operation indicator corresponding to the assistance operation mode, wherein the operation indicator corresponding to the assistance operation mode may include indicating terminal-assistance operation in a case where the assistance operation mode is set to PDU set based QoS handling.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

### In Some Embodiments, the Threshold Value Includes at Least One of:

a maximum round trip time (RTT);
a maximum packet loss rate;
a guaranteed flow bit rate (GFBR); or
an aggregate maximum bit rate (AMBR).

In an embodiment of the present disclosure, the terminal generates the terminal status assistance operation information according to the status information of the terminal, and the terminal status assistance operation information may be configured to indicate the threshold value, wherein the threshold value may include the maximum RTT.

In an embodiment of the present disclosure, the terminal generates the terminal status assistance operation information according to the status information of the terminal, and the terminal status assistance operation information may be configured to indicate the threshold value, wherein the threshold value may include the maximum packet loss rate.

In an embodiment of the present disclosure, the terminal generates the terminal status assistance operation information according to the status information of the terminal, and the terminal status assistance operation information may be configured to indicate the threshold value, wherein the threshold value may include the GFBR.

In an embodiment of the present disclosure, the terminal generates the terminal status assistance operation information according to the status information of the terminal, and the terminal status assistance operation information may be configured to indicate the threshold value, wherein the threshold value may include the AMBR.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In some embodiments, the assistance operation mode functionality includes at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include applying a load balancing functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include cancelling applying a load balancing functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include applying a power consumption balancing functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include cancelling applying a power consumption balancing functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include applying a PDU set based QoS handling functionality to matching traffic.

In an embodiment of the present disclosure, the terminal generates the terminal status assistance operation information according to the status information of the terminal, and the terminal status assistance operation information may be configured to indicate the assistance operation mode functionality, wherein the assistance operation mode functionality may include cancelling applying a PDU set based QoS handling functionality to matching traffic.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In some embodiments, the priority is a priority of applying a QoS rule to matching traffic.

In an embodiment of the present disclosure, the terminal generates the terminal status assistance operation information according to the status information of the terminal, and the terminal status assistance operation information may be configured to indicate the priority, wherein the priority may be the priority of applying a QoS rule to matching traffic.

In some embodiments, the importance is an importance of applying a QoS rule to matching traffic.

In an embodiment of the present disclosure, the terminal generates the terminal status assistance operation information according to the status information of the terminal, and the terminal status assistance operation information may be configured to indicate the importance, wherein the importance may be importance of applying a QoS rule to matching traffic.

In some possible implementations, after executing S21 of generating the terminal status assistance operation information according to the status information of the terminal, the terminal may further send the terminal status assistance operation information to the network, that, the terminal executes S22.
S22, the terminal sends the terminal status assistance operation information to an SMF.

In an embodiment of the present disclosure, the terminal sends the terminal status assistance operation information to the SMF, which can be sent through the access network device. The terminal can send the terminal status assistance operation information to the access network device, and the access network device sends the terminal status assistance operation information to the AMF, which selects and sends it to the SMF.

For example, sending is performed through the following two methods.

Method 1: the terminal status assistance operation information is sent to the SMF by sending a NAS (non-access stratum) message through the access network device, wherein the terminal status assistance operation information can be sent to the SMF by sending PCO (protocol configuration option) and/or reporting terminal 5GSM core network capabilities.

Method 2: the terminal can send an RRC (radio resource control) message to the access network device, and the access network device sends a NGAP (next generation application protocol) message to the SMF, sending the terminal status assistance operation information to the SMF.

It should be noted that in the above two embodiments, the access network device sends a message (PCO or NGAP) to the SMF, which can be sent to the SMF through an AMF.

In embodiments of the present disclosure, the terminal reports the terminal status assistance operation information generated based on the status information of the terminal, which can avoid the terminal from disclosing internal information to the network and protect the information security of the terminal.

In some possible implementations, the SMF receives the terminal status assistance operation information sent by the terminal, and can then send the terminal status assistance operation information to PCF, so that the PCF can generate a policy related rule that matches the business and status information of the terminal based on the terminal status assistance operation information. The SMF executes S23.
S23, the SMF sends the terminal status assistance operation information to the PCF.

In embodiments of the present disclosure, the SMF send the terminal status assistance operation information reported by the terminal to the PCF, which can be sent through the following two methods.

Method 1: the SMF sends the terminal status assistance operation information to the PCF in response to receiving a subscription request for the terminal status assistance operation information of the terminal sent by the PCF, or the SMF may also send the terminal status assistance operation information to the PCF in response to receiving the subscription request for the terminal status assistance operation information of the terminal sent by the PCF and satisfying a reporting condition.

The reporting condition may include receiving the terminal status assistance operation information that has changed and is sent by the terminal, or reporting periodically, or reaching a certain reporting threshold, and so on.

Method 2, the SMF can send the terminal status assistance operation information to the PCF according to subscription information.

The SMF can also send the terminal status assistance operation information to the PCF according to the operator strategy (such as default, reporting upon receiving).

In some possible implementations, the PCF receives the terminal status assistance operation information sent by the SMF, and can then generate a PCC rule that matches the business and status information of the terminal based on the terminal status assistance operation information of the terminal. PCF executes S24.
S24, the PCF generates the PCC rule according to the terminal status assistance operation information.

In an embodiment of the present disclosure, after receiving the terminal status assistance operation information of the terminal from the SMF, the PCF can perform policy determination according to the terminal status assistance operation information to generate the PCC rule.

Generating the PCC rule can generate a new PCC rule, or updating a previous PCC rule to generate the PCC rule.

In embodiments of the present disclosure, the PCF generates/updates the PCC rule according to the terminal status assistance operation information, which can update QoS parameters of service session/service data streams (such as XRM service or multimodal data) of the corresponding UE, including at least one of:
MFBR (maximum flow bit rate) and GFBR of uplink GBR (guaranteed bit rate) traffic;
MFBR and GFBR of downlink GBR traffic;
AMBR of uplink non-GBR traffic;
AMBR of downlink non-GBR traffic;
maximum RTT; or
maximum packet loss rate.

Applying GFBR update to GBR traffic includes increasing or decreasing the GFBR; applying AMBR update to non-GBR traffic includes increasing or decreasing the AMBR; updates to the AMBR includes three levels of UE-AMBR, Session-AMBR and UE-Slice-AMBR, wherein the UE-Slice-AMBR update includes GBR and non-GBR traffic.

In embodiments of the present disclosure, the PCF generates/updates the PCC rule according to the terminal status assistance operation information, which can decide whether to perform the PDU set based QoS handling, or whether to select different QoS profiles and perform different QoS levels based on priorities/importance of PDU sets/PDU set groups.

In embodiments of the present disclosure, the terminal provides the terminal status assistance operation information to the network (e.g. PCF), for supporting the trade-off of throughput/latency/reliability and power consumption (e.g. policy determination and enforcement can be made based on the terminal status assistance operation information).

In embodiments of the present disclosure, the provided terminal status assistance operation information is used as additional information for policy determination, so as to reduce the usage of network resources of the radio interface, especially when there is limited resource.

In embodiments of the present disclosure, it enables the usage of the network resource based on terminal capability (e.g. terminal status assistance operation information).

In embodiments of the present disclosure, it improves user experience by allowing the usage of the applications critical to a user running in a power saving mode while prolonging battery life instead of completely switching it off.

By implementing embodiments of the present disclosure, the terminal generates the terminal status assistance operation information based on the status information of the terminal, and sends the terminal status assistance operation information to the SMF, the SMF sends the terminal status assistance operation information to the PCF, and the PCF generates the PCC rule based on the terminal status assistance operation information. As a result, it is possible to avoid the terminal from disclosing internal information to the network, and it is also possible to generate the PCC rule that matches the business and status of the terminal based on the terminal status assistance operation information of the terminal, in order to save energy consumption of the terminal.

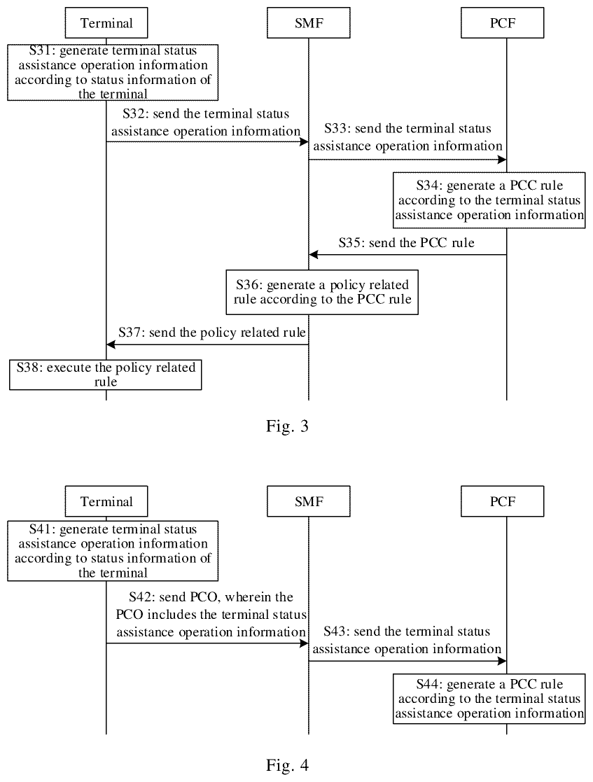

Please refer to FIG. 3, which is a flowchart of another assistance operation method provided in an embodiment of the present disclosure. As shown in FIG. 3, the method may include but is not limited to the following steps.
S31, a terminal generates terminal status assistance operation information according to status information of the terminal
S32, the terminal sends the terminal status assistance operation information to an SMF.
S33, the SMF sends the terminal status assistance operation information to a PCF.
S34, the PCF generates a PCC rule according to the terminal status assistance operation information.

For the relevant descriptions of S31 to S34, reference can be made to the above embodiments, which will not be elaborated here.

In some possible implementations, after generating the PCC rule that matches the business and status information of the terminal according to the terminal status assistance operation information of the terminal, the PCF can send the generated PCC rule to the SMF. The PCF executes S25.
S25, the PCF sends the PCC rule to the SMF.

In an embodiment of the present disclosure, after generating the PCC rule that matches the business and status information of the terminal according to the terminal status assistance operation information of the terminal, the PCF sends the generated PCC rule to the SMF.

In some possible implementations, after receiving the PCC rule sent by the PCF, the SMF can generate a policy related rule according to the PCC rule. The SMF executes S26.
S36, the SMF generates a policy related rule according to the PCC rule.

In an embodiment of the present disclosure, after receiving the PCC rule sent by the PCF, the SMF can generate the policy related rule according to the PCC rule.

In some embodiments, the policy related rule includes at least one of:
updating quality of service (QoS) parameters of business session of the terminal;
updating QoS parameters of business traffic of the terminal;
deciding to perform protocol data unit (PDU) set based QoS handling;
deciding to cancel performing PDU set based QoS handling;
deciding to select different QoS profiles and perform different QoS levels based on priorities of PDU sets;
deciding to select different QoS profiles and perform different QoS levels based on importance of PDU sets;
deciding to select different QoS profiles and perform different QoS levels based on priorities of PDU set groups;
deciding to select different QoS profiles and perform different QoS levels based on importance of PDU set groups;
deciding to cancel selecting different QoS profiles and performing different QoS levels based on priorities of PDU sets;
deciding to cancel selecting different QoS profiles and performing different QoS levels based on importance of PDU sets;
deciding to cancel selecting different QoS profiles and performing different QoS levels based on priorities of PDU set groups; or
deciding to cancel selecting different QoS profiles and performing different QoS levels based on importance of PDU set groups.

In an embodiment of the present disclosure, after receiving the PCC rule sent by the PCF, the SMF can generate the policy related rule according to the PCC rule, wherein the policy related rule may include updating quality of service (QoS) parameters of business session of the terminal.

In an embodiment of the present disclosure, after receiving the PCC rule sent by the PCF, the SMF can generate the policy related rule according to the PCC rule, wherein the policy related rule may include updating QoS parameters of business traffic of the terminal.

In an embodiment of the present disclosure, after receiving the PCC rule sent by the PCF, the SMF can generate the policy related rule according to the PCC rule, wherein the policy related rule may include deciding to perform protocol data unit (PDU) set based QoS handling.

In an embodiment of the present disclosure, after receiving the PCC rule sent by the PCF, the SMF can generate the policy related rule according to the PCC rule, wherein the policy related rule may include deciding to cancel performing PDU set based QoS handling.

In an embodiment of the present disclosure, after receiving the PCC rule sent by the PCF, the SMF can generate the policy related rule according to the PCC rule, wherein the policy related rule may include deciding to select different QoS profiles and perform different QoS levels based on priorities of PDU sets.

In an embodiment of the present disclosure, after receiving the PCC rule sent by the PCF, the SMF can generate the policy related rule according to the PCC rule, wherein the policy related rule may include deciding to select different QoS profiles and perform different QoS levels based on importance of PDU sets.

In an embodiment of the present disclosure, after receiving the PCC rule sent by the PCF, the SMF can generate the policy related rule according to the PCC rule, wherein the policy related rule may include deciding to select different QoS profiles and perform different QoS levels based on priorities of PDU set groups.

In an embodiment of the present disclosure, after receiving the PCC rule sent by the PCF, the SMF can generate the policy related rule according to the PCC rule, wherein the policy related rule may include deciding to select different QoS profiles and perform different QoS levels based on importance of PDU set groups.

In an embodiment of the present disclosure, after receiving the PCC rule sent by the PCF, the SMF can generate the policy related rule according to the PCC rule, wherein the policy related rule may include deciding to cancel selecting different QoS profiles and perform different QoS levels based on priorities of PDU sets.

In an embodiment of the present disclosure, after receiving the PCC rule sent by the PCF, the SMF can generate the policy related rule according to the PCC rule, wherein the policy related rule may include deciding to cancel selecting different QoS profiles and perform different QoS levels based on importance of PDU sets.

In an embodiment of the present disclosure, after receiving the PCC rule sent by the PCF, the SMF can generate the policy related rule according to the PCC rule, wherein the policy related rule may include deciding to cancel selecting different QoS profiles and performing different QoS levels based on priorities of PDU set groups.

In an embodiment of the present disclosure, after receiving the PCC rule sent by the PCF, the SMF can generate the policy related rule according to the PCC rule, wherein the policy related rule may include deciding to cancel selecting different QoS profiles and performing different QoS levels based on importance of PDU set groups.

It should be noted that the above embodiments are not exhaustive and are only illustrative of partial embodiments. The above embodiments can be implemented separately or some embodiments can be combined for implementation. The above embodiments are only illustrative and do not serve as specific limitations on the scope of protection of the disclosure.

In some possible implementations, after receiving the PCC rule sent by the PCF and generating the policy related rule according to the PCC rule, the SMF can send the generated policy related rule to the terminal. The SMF executes S37.
S37, the SFM sends the policy related rule to the terminal.

In an embodiment of the present disclosure, after receiving the policy related rule sent by the PCF, the SMF can send the policy related rule to the terminal.

In some possible implementations, after receiving the policy related rule sent by the SMF, the terminal can execute the policy related rule. The terminal executes S38.
S38, the terminal executes the policy related rule.

In an embodiment of the present disclosure, after receiving the policy related rule sent by the SMF, the terminal can execute the policy related rule.

It can be understood that the policy related rule sent by the SMF is generated based on the PCC rule sent by the PCF. The PCC rule is generated by the PCF based on the terminal status assistance operation information obtained from the status information of the terminal. Therefore, the policy related rule that matches the business and status information of the terminal can be obtained. By executing the policy related rule, the terminal can save energy consumption.

By implementing embodiments of the present disclosure, the terminal generates the terminal status assistance operation information based on the status information of the terminal, and sends the terminal status assistance operation information to the SMF, the SMF sends the terminal status assistance operation information to the PCF, the PCF generates the PCC rule based on the terminal status assistance operation information, and sends the PCC rule to the SMF, the SMF generates the policy related rule based on the PCC rule, and sends the policy related rule to the terminal, and the terminal executes the policy related rule. Thus, it is possible to avoid the terminal from disclosing internal information to the network, and it is also possible to generate the PCC rule that matches the business and status of the terminal according to the terminal status assistance operation information generated from the status information of the terminal, and the terminal can obtain and execute the policy related rule based on PCC rule, which can save energy consumption of the terminal.

Please refer to FIG. 4, which is a flowchart of yet another assistance operation method provided in an embodiment of the present disclosure. As shown in FIG. 4, the method may include but is not limited to the following steps.
S41, a terminal generates terminal status assistance operation information according to status information of the terminal.

For the relevant description of S41, reference can be made to the description in the above embodiments, which will not be repeated here.
S42, the terminal sends PCO to an SMF, wherein the PCO includes the terminal status assistance operation information.

In an embodiment of the present disclosure, the terminal can send PCO (protocol configuration options) to the SMF, to send the terminal status assistance operation information to the SMF.
S43, the SMF sends the terminal status assistance operation information to a PCF.
S44, the PCF generates a PCC rule according to the terminal status assistance operation information.

For the relevant description of S43 and S44, reference can be made to the description in the above embodiments, which will not be repeated here.

For ease of understanding, this disclosure provides an exemplary embodiment.

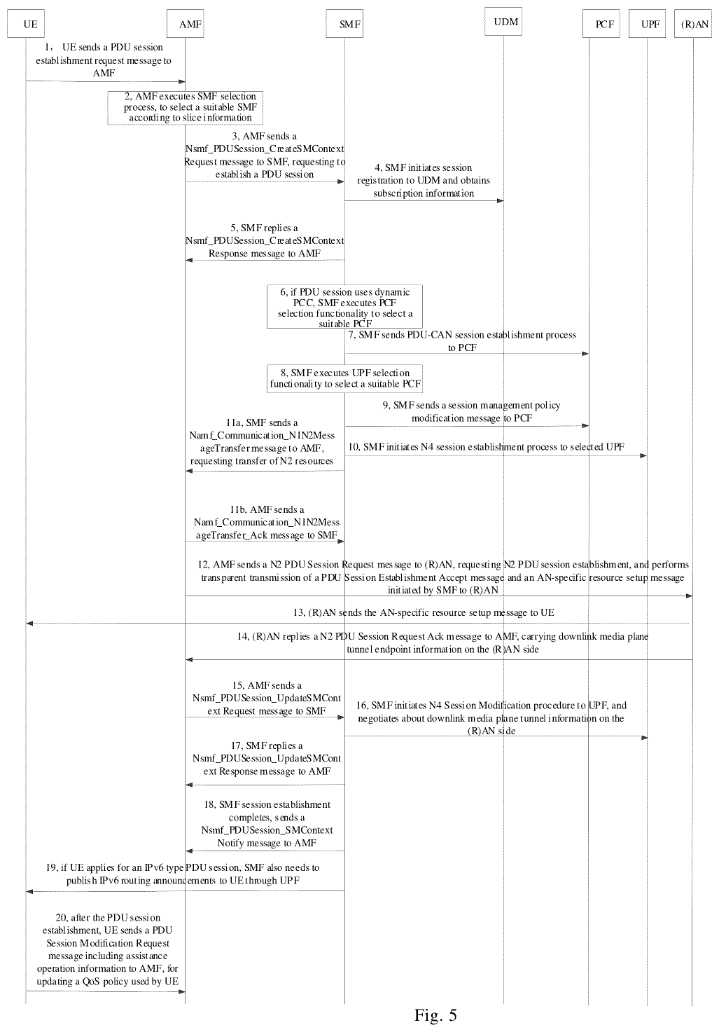

Embodiment 1: In the PDU session establishment process, the terminal status assistance operation information is carried in the PCO to the SMF and sent to the PCF through the SMF; the PCF makes policy determination or updates on terminal/terminal session/terminal business data streams (such as making policy determination or updates on all or part of XRM service data streams, or PDU sessions of XRM service) according to the terminal status assistance operation information. The specific transmission and update processing of related NFs (Network Functions) are shown in FIG. 5.

As shown in FIG. 5, the terminal indicates in the PCO, including terminal status assistance operation information in PDU Session Establishment/Modification Request.

The main process includes: the terminal indicates in the PCO, including terminal status assistance operation information in the registration request message (e.g., in the initial registration and the mobility registration update as part of the terminal 5GMM core network capability).
Step 1, the terminal capability to support the provision of “terminal status assistance operation indication or information” (UE status assistance operation indication or information) included in the PCO in the PDU session establishment request message.

The terminal can generate the corresponding “terminal status assistance operation indication or information” (UE status assistance operation indication or information) based on the status information of the terminal (e.g., battery level of the terminal, battery life of the terminal, powered mode including battery-powered or mains/wall-powered, overheating status of the terminal). The terminal status assistance operation indication or information may include the contents shown in Table 1 above.
Steps 2 and 3, the AMF stores the terminal status assistance operation indication or information (UE status assistance operation indication or information) in the context of the terminal, selects the corresponding SMF, and sends an SM context create request, the message carrying the N1 SM container in step 1, the PCO carrying the terminal status assistance operation indication or information.
Step 4, the SMF checks the subscription data and/or event subscription, combined with local policies, to confirm whether the session can be created, whether to execute subscription event reporting, whether to execute local policies and QoS authorization (if there is no PCF deployment, SMF executes static rule activation and QoS authorization updates), etc.

The SMF checks the event subscription (and/or combined with subscription data or operator policies) to confirm whether to execute subscription event reporting. For example, if the terminal status assistance operation indication or information event (UE status assistance operation indication or information event) is subscribed, it is confirmed whether the subscription reporting condition is met (for example, the UE status assistance operation indication or information changes, various thresholds are reached, or patterns match or change, or reporting immediately upon receiving, or periodic reporting, etc.), and reporting is executed according to the subscription and reporting requirement. Alternatively, the SMF will, combined with the subscription data or operator policies, confirm whether to transmit the UE status Assistance Operation indication or information to PCF.

The SMF sends the UE status Assistance Operation indication or information to the PCF, including two ways: 1) the PCF sends a subscription request for UE status Assistance Operation indication or information to the SMF, and the SMF reports the UE status Assistance Operation indication or information to the PCF after meeting the reporting condition (reporting condition may be, for example, receiving changed UE status Assistance Operation indication/information, reporting periodically, reporting when reaching a certain reporting threshold, or reporting upon receiving an immediate reporting instruction); 2) the SMF makes a decision to send the UE status Assistance Operation indication or information to the PCF based on subscription information or operator policies (e.g. default, reporting upon receiving).

For example, the SMF confirms whether the UE status Assistance Operation indication or information complies with user subscription and local policies. If no, the SMF can reject the session creation of the XRM service/multimodal service, or receive session creation based on local policies but do not support XRM service/multimodal service.
Step 7, if the PDU session uses dynamic PCC, the SMF performs PCF selection; Otherwise, the SMF will execute local policies. This PDU session request supports XRM services/multimodal services. SMF and PCF generate/activate corresponding XRM rules/multimodal data rules based on the application information provided by the subscription and AF (Application Function), or generate/activate enhanced data flow PCC rules that support XRM and multimodal sessions (such as associating XRM service data flows, matching XRM service and multimodal service QoS, including GFBR, PDB (Packet Delay Budget), MDBV (Maximum Data Burst Volume) matching for XRM and multimodal service data flows, etc.).

The PCF obtains “UE Status Assistance Operation indication or information” from the SMF; the PCF executes policy determination, combined with the obtained “UE status assistance operation indication or information”. For example:
generate/update the PCC rule;
update the QoS parameters of the corresponding service session/service data flow (e.g. XRM service or multimodal data) of the UE, including: uplink or downlink GBR/Non GBR data flow bit rate (MFBR and GFBR of GBR traffic, or AMBR of Non GBR traffic); and/or Maximum RTT; and/or a Maximum Packet Loss Rate;
wherein, performing GFBR updates on GBR data flow, including reducing or increasing GFBG; performing relevant AMBR updates on Non GBR data flow, including reducing or increasing AMBR; updates to AMBR, including three levels of UE-AMBR, Session-AMBR, and UE-Slice-AMBR; wherein the UE-Slice-AMBR update includes GBR and Non GBR data flow;
decide whether to execute PDU set based QoS handling; whether to select different QoS profiles and execute different QoS levels based on the priority/importance/independence of PDU set/PDU set group;

If a PDU session has already been created, the PCF may trigger the SM session modification process and issue the updated PCC rule to the SMF for executing QoS rule mapping, and then issuing it to UPF and/or RAN and/or UE for execution.

The PCF can perform the following QoS updates based on the UE status Assistance Operation indication or information (which can be used as a dependent claim):
If UL and/or DL Session-AMBR is sent to the SMF, it should be forwarded to the UPF for execution (UL and/or DL Session-AMBR shall be enforced by the UPF, if the UPF receives the Session-AMBR values from the SMF).
If Session-AMBR is sent to the UE, the UE executes the updated uplink Session-AMBR (The UE shall perform UL rate limitation on PDU Session basis for Non-GBR traffic using Session-AMBR, if the UE receives a Session-AMBR).
If UE-AMBR is sent to the PCF, then the (R)AN shall enforce UE-AMBR in UL and DL per UE for Non-GBR QoS flows.
If MFBR is updated by the PCF, then for GBR QoS flows, the UPF executes the updated downlink MFBR (The MFBR is enforced in the UPF in the Downlink for GBR QoS Flows). For GBR QoS flows, (R)AN executes the updated uplink and downlink MFBR. (The MFBR is enforced in the (R)AN in the Downlink and Uplink for GBR QoS Flows.)
If the PCF updates UE-Slice-AMBR, and RAN receives the updated UE-Slice-AMBR, then if feasible, RAN shall apply this UE-Slice-MBR for all PDU sessions of the UE corresponding to S-NSSAI which have an active user plane.

If the RAN supporting the operator receives a UE-slice-MBR for S-NSSAI from the AMF, the RAN shall apply this UE-slice-MBR for all PDU sessions of the UE corresponding to S-NSSAI which have an active user plane if feasible.
1) Whenever a request for a GBR QoS Flow establishment or modification is received, the RAN admission control shall ensure that the sum of the GFBR values of the admitted GBR QoS Flows is not exceeding the UE-Slice-MBR and, if the QoS Flow cannot be admitted, the RAN shall reject the establishment/modification of the QoS Flow. 2) The RAN shall ensure that the aggregated bitrate across all GBR and Non-GBR QoS Flows belonging to those PDU Sessions is not exceeding the UE-Slice-MBR, while always guaranteeing the GFBR of every GBR QoS Flow of those PDU Sessions.
Step 9 or 20, SM session modification process, where the PCF can provide QoS information updated based on “UE status assistance operation indication or information” as described in step 7, to be used by UPF/RAN/UE to perform QoS updates for different levels of data flows, as described in step 7.

The remaining steps can be executed by referring to the session creation and update process in related technologies.

It should be noted that in embodiments of the present disclosure, S41 to S44 can be implemented separately or in combination with any other step in embodiments of the present disclosure, such as S21 to S24 and/or S31 to S38, which is not limited in embodiments of the present disclosure.

By implementing embodiments of the present disclosure, the terminal generates the terminal status assistance operation information based on the status information of the terminal, and sends PCO to the SMF, where the PCO includes the terminal status assistance operation information. The SMF sends the terminal status assistance operation information to the PCF, and the PCF generates the PCC rule based on the terminal status assistance operation information. As a result, it is possible to avoid the terminal from disclosing internal information to the network, and it is also possible to generate the PCC rule that matches the business and status of the terminal based on the terminal status assistance operation information generated from the status information of the terminal, in order to save energy consumption of the terminal.

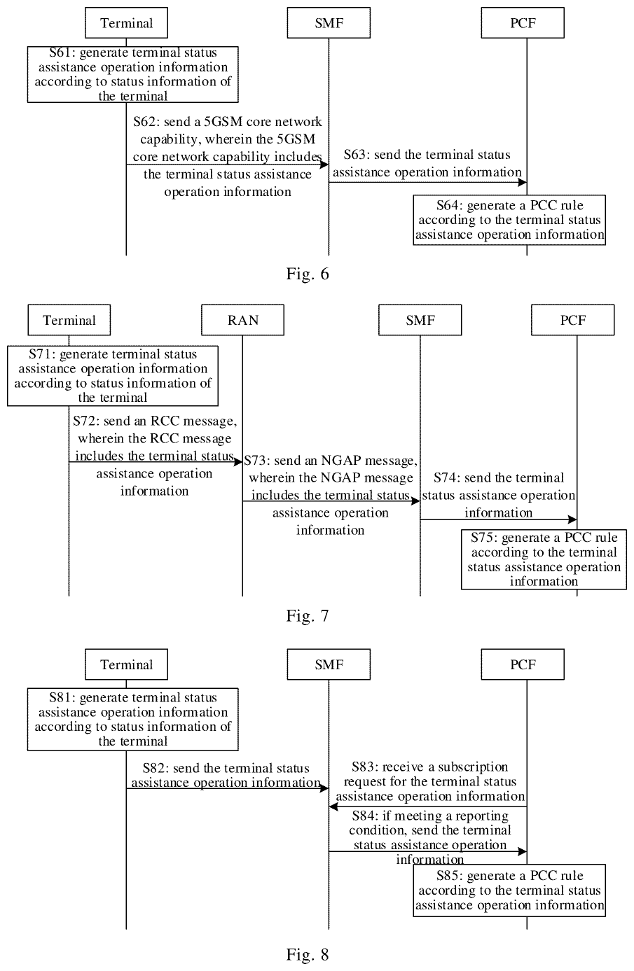

Please refer to FIG. 6, which is a flowchart of yet another assistance operation method provided in an embodiment of the present disclosure. As shown in FIG. 6, the method may include but is not limited to the following steps.
S61, a terminal generates terminal status assistance operation information according to status information of the terminal.

For the relevant description of S61, reference can be made to the description in the above embodiments, which will not be repeated here.
S62, the terminal sends 5GSM core network capability to a SMF, wherein the 5GSM core network capability includes the terminal status assistance operation information.

In an embodiment of the present disclosure, the terminal can send the 5GSM core network capability to the SMF, so as to send the terminal status assistance operation information to the SMF.
S63, the SMF sends the terminal status assistance operation information to a PCF.
S64, the PCF generates a PCC rule according to the terminal status assistance operation information.

For the relevant description of S31 and S64, reference can be made to the description in the above embodiments, which will not be repeated here.

For ease of understanding, the present disclosure provides an exemplary embodiment.

Embodiment 2, in the PDU session establishment process, the UE status Assistance Operation indication or information is provided to the SMF as the 5GSM Core Network Capability and sent to the PCF through the SMF; the PCF performs QoS updates on UE/UE session/UE service data streams based on the “UE status Assistance Operation indication or information” (e.g. QoS updates on all or part of XRM service data streams, or PDU sessions of XRM services). The specific transmission and update processing of related NFs are shown in FIG. 5.

As shown in FIG. 5, step 1: the terminal sends a NAS message to the AMF to initiate the PDU session establishment process requested by the UE. The N1 SM container carries a session establishment request, and the request message carries 5GSM Capability, which includes “UE Status Assistance Operation Indication or Information” to inform the network of the “UE Status Assistance Operation Indication or Information”.

Steps 2 and 3: the AMF stores the UE status Assistance Operation indication or information in the UE context, selects the corresponding SMF and sends a SM context create request, the request message carrying the N1 SM container in step 1, including the 5GSM Core Network Capability including the UE status Assistance Operation indication or information.

Steps 4, 7, 9, and 20 are the same as those in Embodiment 1, and will not be repeated here.

The remaining steps can be executed according to the session creation and update process in the related technologies.

It should be noted that in embodiments of the present disclosure, S61 to S64 can be implemented separately or in combination with any other step in embodiments of the present disclosure, such as S21 to S24 and/or S31 to S38 in embodiments of the present disclosure, which is not limited in embodiments of the present disclosure.

By implementing embodiments of the present disclosure, the terminal generates the terminal status assistance operation information based on the status information of the terminal, and sends the 5GSM core network capability to the SMF, where the 5GSM core network capability includes the terminal status assistance operation information. The SMF sends the terminal status assistance operation information to the PCF, and the PCF generates the PCC rule based on the terminal status assistance operation information. As a result, it is possible to avoid the terminal from disclosing internal information to the network, and it is also possible to generate the PCC rule that matches the business and status of the terminal based on the terminal status assistance operation information generated from the status information of the terminal, in order to save energy consumption of the terminal.

Please refer to FIG. 7, which is a flowchart of yet another assistance operation method provided in an embodiment of the present disclosure. As shown in FIG. 7, the method may include but is not limited to the following steps.
S71, a terminal generates terminal status assistance operation information according to status information of the terminal.

For the relevant description of S71, reference can be made to the description in the above embodiments, which will not repeated here.
S72, the terminal sends an RRC message including the terminal status assistance operation information to an access network device.
S73, the access network device sends an NGAP message to an SMF, wherein the NGAP message includes the terminal status assistance operation information.

In an embodiment of the present disclosure, after generating the terminal status assistance operation information based on the status information of the terminal, the terminal can send the assistance operation information to the network by sending the RRC message to the access network device (RAN), where the RRC message includes the terminal status assistance operation information.

After receiving the RRC message sent by the terminal, the access network device can obtain the terminal status assistance operation information in the RRC message and send an NGAP message to the SMF, where the NGAP message includes the terminal status assistance operation information.
S74, the SMF sends the terminal status assistance operation information to a PCF.
S75, the PCF generates a PCC rule according to the terminal status assistance operation information.

For the relevant description of S74 and 75, reference can be made to the description in the above embodiments, which will not repeated here.

For case of understanding, the disclosure provides an exemplary embodiment.

Embodiment 3: In the PDU session establishment process, the terminal status assistance operation indication or information (UE status assistance operation indication/information) is carried to the RNG-RAN; wherein, the UE status Assistance Operation indication or information is transmitted to RAN-RAN as AN parameters in the AN (Access Network) message. Alternatively, the UE status Assistance Operation indication or information can be simultaneously transmitted as NAS parameters in the N2 message to the RGN-RAN and directly forwarded to the SMF; or, after receiving the “UE status assistance operation indication or information” from the AN parameters, in combination with the operator policy or network configuration, the NG-RAN puts the received “UE status assistance operation indication or information” into a NAS message and transmits it to the SMF; transferred from SMF to PCF; the PCF generates or updates the PCC rule for UE/UE sessions/UE service data streams based on the “UE status Assistance Operation indication or information” (e.g. performs QoS updates for all or part of XRM service data streams, or PDU sessions of XRM services). The specific transmission and update processing of related NFS are shown in FIG. 5.

As shown in FIG. 5, step 1: in the PDU session establishment process, the terminal carries the UE status Assistance Operation indication or information to the RNG-RAN; wherein, the UE status Assistance Operation indication or information is transmitted to the RAN-RAN as AN parameters in the AN message. Alternatively, the UE status Assistance Operation indication or information can be simultaneously transmitted as NAS parameters in the N2 message to the RGN-RAN and directly forwarded to the AMF and SMF; or, after receiving the “UE status assistance operation indication or information” from the AN parameters, in combination with the operator strategy or network configuration, the NG-RAN puts the received “UE status assistance operation indication or information” into a NAS message and transmit it to the AMF and SMF. The NG-RAN stores the received UE status Assistance Operation indication or information.

Step 2: the AMF stores the received UE status Assistance Operation indication or information, and selects the SMF to execute the PDU session creation according to the SMF selection strategy.

Step 3: the AMF transmits the “UE Status Assistance Operation Indication/Information” received in step 1, which is included in the NAS parameters of N2 message, to AMF. Alternatively, after retrieving the “UE Status Assistance Operation Indication/Information” from the AN parameters received by NG-RAN, combined with the operator strategy or network configuration, the received “UE Status Assistance Operation Indication/Information” will be included in the NAS message and transmitted to AMF and SMF.

Step 4: SMF stores the received “UE Status Assistance Operation Indication/Information”. Based on the subscription information, the operator strategy, and the received UE status Assistance Operation indication or information, the SMF makes the decision to create a session. The SMF sends the received UE status Assistance Operation indication or information to PCF for service policy decision-making, as well as billing and QoS authorization (e.g. XRM service/service group policy decision-making, billing and QoS authorization of XRM SDF (steering decision function) business data flow).

Steps 4, 7, 9, and 20 are the same as in Embodiment 1, and will not be repeated here.

The remaining steps can be executed according to the session creation and update process of related technologies.

It should be noted that in embodiments of the present disclosure, S71 to S75 can be implemented separately, or combined with any other step in embodiments of the present disclosure, such as S21 to S24 and/or S31 to S38 in embodiments of the present disclosure, which is not limited in the present disclosure.

By implementing embodiments of the present disclosure, the terminal generates the terminal status assistance operation information based on the status information of the terminal, the terminal sends the RRC message including the terminal status assistance operation information to the access network device, and the access network device sends the NGAP message to the SMF, where the NGAP message includes the terminal status assistance operation information, the SMF sends the terminal status assistance operation information to the PCF, and the PCF generates the PCC rule based on the terminal status assistance operation information. As a result, it is possible to avoid the terminal from disclosing internal information to the network, and it is also possible to generate the PCC rule that matches the business and status of the terminal based on the terminal status assistance operation information generated from the status information of the terminal, in order to save energy consumption of the terminal.

Please refer to FIG. 8, which is a flowchart of yet another assistance operation method provided in an embodiment of the present disclosure. As shown in FIG. 8, the method may include but is not limited to the following steps.
S81, a terminal generates terminal status assistance operation information according to status information of the terminal.
S82, the terminal sends the terminal status assistance operation information to an SMF.

For the relevant description of S81 and S82, reference can be made to description in the above embodiments, which will not be repeated here.
S83, the SMF receives a subscription request for the terminal status assistance operation information sent by a PCF.
S84, the SMF sends the terminal status assistance operation information to the PCF when a reporting condition is met.

In an embodiment of the present disclosure, when the SMF receives a subscription request for the terminal status assistance operation information sent by the PCF, it sends the terminal status assistance operation information to the PCF. The SMF can also send the terminal status assistance operation information to the PCF when it receives a subscription request for the terminal status assistance operation information sent by the PCF and the reporting condition is met.

The reporting condition may include receiving the terminal status assistance operation information that has changed sent by the terminal, or reporting periodically, or reaching a certain reporting threshold, and so on.
S85, the PCF generates a PCC rule according to the terminal status assistance operation information.

For the relevant description of S85, reference can be made to the description in the above embodiments, which will not be repeated here.

It should be noted that in embodiments of the present disclosure, S81 to S85 can be implemented separately, or combined with any other step in embodiments of the present disclosure, such as S21 to S24 and/or S31 to S38 in embodiments of the present disclosure, which is not limited in the present disclosure.

By implementing embodiments of the present disclosure, the terminal generates the terminal status assistance operation information based on the status information of the terminal, the terminal sends the terminal status assistance operation information to the SMF, the SMF receives the subscription request for the terminal status assistance operation information sent by the PCF, and the SMF sends the terminal status assistance operation information to the PCF when the reporting condition is met, and the PCF generates the PCC rule based on the terminal status assistance operation information. As a result, it is possible to avoid the terminal from disclosing internal information to the network, and it is also possible to generate the PCC rule that matches the business and status of the terminal based on the terminal status assistance operation information generated from the status information of the terminal, in order to save energy consumption of the terminal.

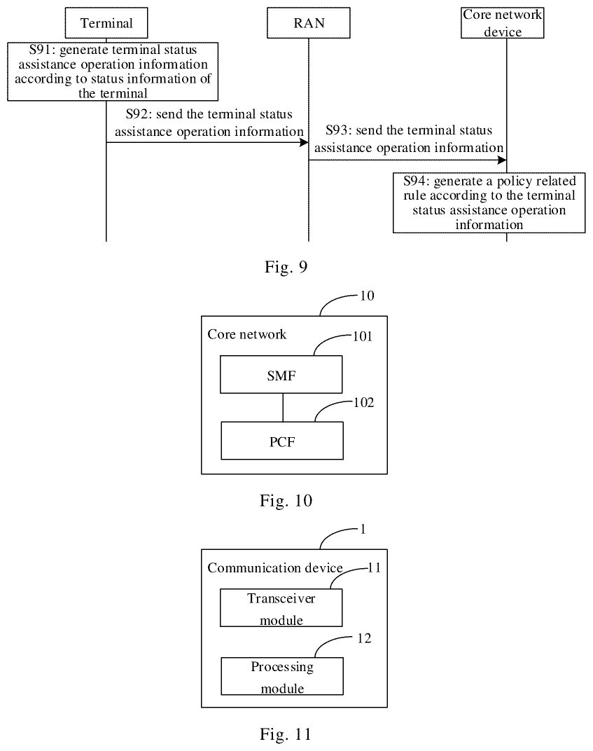

Please refer to FIG. 9, which is a flowchart of yet another assistance operation method provided in an embodiment of the present disclosure. As shown in FIG. 9, the method may include but is not limited to the following steps.
S91, a terminal generates terminal status assistance operation information according to status information of the terminal.

For the relevant description of S91, reference can be made to the description in the above embodiments, which will not be repeated here.
S92, the terminal sends the terminal status assistance operation information to a core network through an access network device.

In an embodiment of the present disclosure, the terminal sends the terminal status assistance operation information to the core network through the access network device, where the terminal can send an NAS message to the core network through the access network device, wherein the NAS messages include the terminal status assistance operation information.

In an embodiment of the present disclosure, the terminal sends the terminal status assistance operation information to the core network through the access network device, where the terminal can send an RRC messages to the access network device, where the RRC message includes the terminal status assistance operation information. After receiving the RRC message, the access network device sends an NGAP message to the core network, where the NGAP message includes the terminal status assistance operation information.
S93, the core network receives the terminal status assistance operation information.
S94, the core network generates a policy related rule according to the terminal status assistance operation information.

In an embodiment of the present disclosure, the core network receives the terminal status assistance operation information, and then can generate the policy related rule according to the terminal status assistance operation information.

The core network may include the SMF and the PCF, which jointly generate the policy related information based on the terminal status assistance operation information. The process can refer to the relevant descriptions in the above embodiments, which will not be repeated here.

It should be noted that in embodiments of the present disclosure, S91 to S94 can be implemented separately, or combined with any other step in embodiments of the present disclosure, such as S21 to S24 and/or S31 to S38 in embodiments of the present disclosure, which is not limited in the present disclosure.

By implementing embodiments of the present disclosure, the terminal generates the terminal status assistance operation information based on the status information of the terminal, the terminal sends the terminal status assistance operation information to the core network through the access network device, the core network receives the terminal status assistance operation information, and the core network generates the policy related rule based on the terminal status assistance operation information. As a result, it is possible to avoid the terminal from disclosing internal information to the network, and it is also possible to generate the PCC rule that matches the business and status of the terminal based on the terminal status assistance operation information generated from the status information of the terminal, in order to save energy consumption of the terminal.

In the above embodiments provided in this disclosure, the scheme provided in this disclosure is mainly introduced from the perspective of interaction between devices. It can be understood that each device includes corresponding hardware structures and/or software modules to perform the above functions. Technicians in this field should easily realize that, based on the algorithm steps described in the embodiments disclosed in this disclosure, this disclosure can be implemented in the form of hardware or a combination of hardware and computer software. Whether a certain function is executed through hardware or computer software driven hardware depends on the specific application and design constraints of the technical solution. Professional technicians can use different methods to achieve the described functionality for each specific application, but such implementation should not be considered beyond the scope of this disclosure.

Please refer to FIG. 10, which is a block diagram of a core network 10 provided in an embodiment of the present disclosure.

As shown in FIG. 10, the core network includes an SMF 101 and a PCF 102.

The core network 10 is configured to receive terminal status assistance operation information.

The core network 10 is further configured to generate a policy related rule according to the terminal status assistance operation information.

The SMF 101 is configured to receive the terminal status assistance operation information from an access network device through an AMF.

The SMF 101 is further configured to send the terminal status assistance operation information to the PCF.

The PCF 102 is configured to generate a PCC rule according to the terminal status assistance operation information.

The PCF 102 is further configured to send the PCC rule to the SMF.

The SMF 101 is further configured to generate the policy related rule according to the PCC rule.

Regarding the core network 10 in the above embodiment, the specific ways in which each module performs operations have been described in detail in the relevant embodiment embodiments, and will not be elaborated here.

The core network 10 provided in the above embodiments of the present disclosure achieves the same or similar beneficial effects as the assistance operation methods provided in some of the above embodiments, and will not be repeated here.

Please refer to FIG. 11, which is a block diagram of a communication device provided in an embodiment of the present disclosure. The communication device shown in FIG. 11 may include a transceiver module 11 and a processing module 12. The transceiver module 11 may include a sending module and/or a receiving module. The sending module is used to implement the sending function, and the receiving module is used to implement the receiving function. The transceiver module 11 may implement the sending function and/or the receiving function.

The communication device 1 is arranged on a terminal side, and includes a transceiver module 12 and a processing module 12.

The processing module 12 is configured to generate terminal status assistance operation information according to status information of the terminal.

The transceiver module 11 is configured to send the terminal status assistance operation information to a core network through an access network device.

In some embodiments, the transceiver module 11 is further configured to send a non-access stratum (NAS) message to the core network through the access network device, wherein the NAS message includes the terminal status assistance operation information; or send a next generation application protocol (NGAP) message to the core network through the access network device, wherein the NGAP message includes the terminal status assistance operation information.

In some embodiments, the transceiver module 11 is further configured to send the terminal status assistance operation information to an SMF of the core network through the access network device.

In some embodiments, the terminal status assistance operation information includes at least one of:
a terminal status assistance operation indication;
terminal status assistance operation demand information; or
terminal status assistance operation policy information.

In some embodiments, the status information of the terminal includes at least one of:
a battery level;
a battery life;
a powered mode;
an overheating status; or
a load status.

In some embodiments, the terminal status assistance operation information is configured to indicate at least one of:
an assistance operation mode;
an operation indicator corresponding to the assistance operation mode;
a threshold value;
an assistance operation mode functionality;
a priority; or
an importance.

In some embodiments, the assistance operation mode is configured to indicate the assistance operation mode can be applied to matching traffic and associated parameters.

In some embodiments, the operation indicator corresponding to the assistance operation mode includes at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to PDU set based QoS handling; or
indicating terminal-assistance operation in a case where the assistance operation mode is set to PDU set based QoS handling.

In some embodiments, the threshold value includes at least one of:
a maximum round trip time (RTT);
a maximum packet loss rate;
a guaranteed flow bit rate (GFBR); or
an aggregate maximum bit rate (AMBR).

In some embodiments, the assistance operation mode functionality includes at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

In some embodiments, the priority is a priority of applying a QoS rule to matching traffic.

In some embodiments, the importance is an importance of applying a QoS rule to matching traffic.

The communication device is arranged on a SMF side, and includes a transceiver module 11.

The transceiver module 11 is configured to receive terminal status assistance operation information.

The transceiver module 11 is further configured to send the terminal status assistance operation information to the PCF.

In some embodiments, the transceiver module 11 is further configured to receive a PCC rule sent by the PCF, wherein the PCC rule is generated by the PCF according to the terminal status assistance operation information sent by the SMF.

The device further includes a processing module 12. The processing module 12 is configured to generate a policy related rule according to the PCC rule.

The transceiver module 11 is further configured to send the policy related rule to the terminal.

In some embodiments, the transceiver module 11 is further configured to send the terminal status assistance operation information to the PCF, in response to receiving a subscription request for the terminal status assistance operation information and satisfying a reporting condition; or send the terminal status assistance operation information to the PCF according to subscription information.

In some embodiments, the terminal status assistance operation information includes at least one of:
a terminal status assistance operation indication;
terminal status assistance operation demand information; or
terminal status assistance operation policy information.

In some embodiments, the terminal status assistance operation information is configured to indicate at least one of:
an assistance operation mode;
an operation indicator corresponding to the assistance operation mode;
a threshold value;
an assistance operation mode functionality;
a priority; or
an importance.

In some embodiments, the assistance operation mode is configured to indicate the assistance operation mode can be applied to matching traffic and associated parameters.

In some embodiments, the operation indicator corresponding to the assistance operation mode includes at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to PDU set based QoS handling; or
indicating terminal-assistance operation in a case where the assistance operation mode is set to PDU set based QoS handling.

### In Some Embodiments, the Threshold Value Includes at Least One of:

a maximum round trip time (RTT);
a maximum packet loss rate;
a guaranteed flow bit rate (GFBR); or
an aggregate maximum bit rate (AMBR).

In some embodiments, the assistance operation mode functionality includes at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

In some embodiments, the priority is a priority of applying a QoS rule to matching traffic.

In some embodiments, the importance is an importance of applying a QoS rule to matching traffic.

### In Some Embodiments, the Policy Related Rule Includes at Least One of:

updating quality of service (QoS) parameters of business session of the terminal;
updating QoS parameters of business traffic of the terminal;
deciding to perform protocol data unit (PDU) set based QoS handling;
deciding to cancel performing PDU set based QoS handling;
deciding to select different QoS profiles and perform different QoS levels based on priorities of PDU sets;
deciding to select different QoS profiles and perform different QoS levels based on importance of PDU sets;
deciding to select different QoS profiles and perform different QoS levels based on priorities of PDU set groups;
deciding to select different QoS profiles and perform different QoS levels based on importance of PDU set groups;
deciding to cancel selecting different QoS profiles and perform different QoS levels based on priorities of PDU sets;
deciding to cancel selecting different QoS profiles and perform different QoS levels based on importance of PDU sets;
deciding to cancel selecting different QoS profiles and performing different QoS levels based on priorities of PDU set groups; or
deciding to cancel selecting different QoS profiles and performing different QoS levels based on importance of PDU set groups.

The communication device 11 is arrange on a PCF side, and includes the transceiver module 11 and the processing module 12.

The transceiver module 11 is configured to receive terminal status assistance operation information sent by an SMF.

The processing module 12 is configured to generate a PCC rule according to the terminal status assistance operation information.

In some embodiments, the transceiver module 11 is further configured to send the PCC rule to the SMF.

In some embodiments, the transceiver module 11 is further configured to send a subscription request for the terminal status assistance operation information to the SMF.

In some embodiments, the terminal status assistance operation information includes at least one of:
a terminal status assistance operation indication;
terminal status assistance operation demand information; or terminal status assistance operation policy information.

In some embodiments, the terminal status assistance operation information is configured to indicate at least one of:
an assistance operation mode;
an operation indicator corresponding to the assistance operation mode;
a threshold value;
an assistance operation mode functionality;
a priority; or
an importance.

In some embodiments, the assistance operation mode is configured to indicate the assistance operation mode can be applied to matching traffic and associated parameters.

In some embodiments, the operation indicator corresponding to the assistance operation mode includes at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to PDU set based QoS handling;
indicating terminal-assistance operation in a case where the assistance operation mode is set to PDU set based QoS handling.

### In Some Embodiments, the Threshold Value Includes at Least One of:

a maximum round trip time (RTT);
a maximum packet loss rate;
a guaranteed flow bit rate (GFBR); or
an aggregate maximum bit rate (AMBR).

In some embodiments, the assistance operation mode functionality includes at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

In some embodiments, the priority is a priority of applying a QoS rule to matching traffic.

In some embodiments, the importance is an importance of applying a QoS rule to matching traffic.

The communication device 1 is arranged on a core network side, and includes the transceiver module 11 and the processing module 12.

The transceiver module 11 is configured to receive terminal status assistance operation information.

The processing module 12 is configured to generate a policy related rule according to the terminal status assistance operation information.

In some embodiments, an SMF of the core network receives the terminal status assistance operation information through an access network device.

In some embodiments, the SMF of the core network sends the terminal status assistance operation information to a PCF of the core network;
the PCF of the core network receives the terminal status assistance operation information;
the PCF of the core network generates a PCC rule according to the terminal status assistance operation information;
the PCF of the core network sends the PCC rule to the SMF of the core network;
the SMF of the core network receives the PCC rule;
the SMF of the core network generates the policy related rule according to the PCC rule.

In some embodiments, the terminal status assistance operation information is configured to indicate at least one of:
an assistance operation mode;
an operation indicator corresponding to the assistance operation mode;
a threshold value;
an assistance operation mode functionality;
a priority; or
an importance.

In some embodiments, the assistance operation mode is configured to indicate the assistance operation mode can be applied to matching traffic and associated parameters.

In some embodiments, the operation indicator corresponding to the assistance operation mode includes at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to PDU set based QoS handling;
indicating terminal-assistance operation in a case where the assistance operation mode is set to PDU set based QoS handling.

### In Some Embodiments, the Threshold Value Includes at Least One of:

a maximum round trip time (RTT);
a maximum packet loss rate;
a guaranteed flow bit rate (GFBR); or
an aggregate maximum bit rate (AMBR).

In some embodiments, the assistance operation mode functionality includes at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

In some embodiments, the priority is a priority of applying a QoS rule to matching traffic.

In some embodiments, the importance is an importance of applying a QoS rule to matching traffic.

Regarding the communication device 1 in the above embodiments, the specific ways in which each module performs operations have been described in detail in the relevant embodiments of the method, and will not be elaborated here.

The communication device 1 provided in the above embodiments of the present disclosure achieves the same or similar beneficial effects as the assistance operation methods provided in some of the above embodiments, and will not be repeated here.

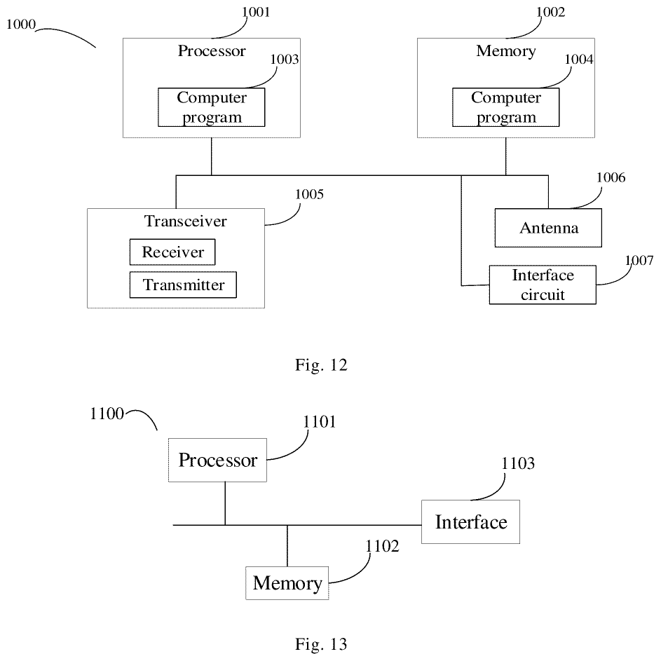

Please refer to FIG. 12, which is a block diagram of another communication device 1000 provided in an embodiment of the present disclosure. The communication device 1000 may be a terminal, or may be an SMF, or may be a PCF. The device can be used to implement the methods described in the above method embodiments, which can be referred to in the description of the above method embodiments.

The communication device 1000 may include one or more processors 1001. The processor 1001 may be a general-purpose processor or a dedicated processor, etc. For example, it may be a baseband processor or a central processor. The baseband processor can be used to process communication protocols and communication data, while the central processor can be used to control communication devices (such as base stations, baseband chips, terminals, terminal chips, DU or CU, etc.), execute computer programs, and process data from computer programs.

Optionally, the communication device 1000 may also include one or more memories 1002, on which computer programs 1004 may be stored. The memory 1002 executes the computer programs 1004 to enable the communication device 1000 to perform the methods described in the above method embodiments. Optionally, the memory 1002 can also store data. The communication device 1000 and the memory 1002 can be set separately or integrated together.

Optionally, the communication device 1000 may also include a transceiver 1005 and an antenna 1006. The transceiver 1005 can be referred to as a transceiver unit, transceiver machine, or transceiver circuit, etc., used to achieve transceiver functions. The transceiver 1005 can include a receiver and a transmitter, where the receiver can be referred to as a receiver unit or receiving circuit, etc., used to achieve the receiving function; the transmitter can be referred to as a transmitter unit or a transmission circuit, etc., used to implement the transmission function.

Optionally, the communication device 1000 may also include one or more interface circuits 1007. The interface circuit 1007 is used to receive code instructions and transmit them to the processor 1001. The processor 1001 executes the code instructions to cause the communication device 1000 to perform the method described in the above method embodiments.

The communication device 1000 is the terminal, the transceiver 1005 is configured to execute S22 in FIGS. 2, S32 and S37 in FIG. 3, S42 in FIG. 4, S62 in FIG. 6, S72 in FIG. 7, or S82 in FIG. 8, and the processor 1001 is configured to execute S21 in FIGS. 2, S31 and S38 in FIG. 3, S41 in FIG. 4, S61 in FIG. 6, S71 in FIG. 7, or S81 in FIG. 8.

The communication device 1000 is the SMF, the transceiver 1005 is configured to execute S22 and S23 in FIGS. 2, S32, S33, S35 and S37 in FIGS. 3, S42 and S43 in FIGS. 4, S62 and S63 in FIGS. 6, S73 and S74 in FIG. 7, or S82, S83 and S84 in FIG. 8, and the processor 1001 is configured to execute S36 in FIG. 3.

The communication device 1000 is the PCF, the transceiver 1005 is configured to execute S23 in FIGS. 2, S33 and S35 in FIG. 3, S43 in FIG. 4, S63 in FIG. 6, S74 in FIG. 7, or S83 and S84 in FIG. 8, and the processor 1001 is configured to execute S24 in FIG. 2, S34 in FIG. 3, S44 in FIG. 4, S64 in FIG. 6, S75 in FIG. 7, or S85 in FIG. 8.

In one implementation, the processor 1001 may include a transceiver for implementing receiving and transmitting functions. For example, the transceiver can be a transceiver circuit, or an interface, or an interface circuit. The transceiver circuit, interface, or interface circuit used to implement the receiving and sending functions can be separate or integrated together. The above-mentioned transceiver circuit, interface or interface circuit can be used for reading and writing code/data, or the above-mentioned transceiver circuit, interface or interface circuit can be used for signal transmission or transfer.

In one implementation, the processor 1001 may store a computer program 1003 that runs on the processor 1001 and enables the communication device 1000 to perform the method described in the above method embodiments. The computer program 1003 may be fixed in the processor 1001, in which case the processor 1001 may be implemented by hardware.

In one implementation, the communication device 1000 may include a circuit that can perform the functions of sending, receiving, or communicating as described in the aforementioned method embodiments. The processor and transceiver described in this disclosure can be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver can also be manufactured using various IC process technologies, such as complementary metal oxide semiconductor (CMOS), n-type metal oxide semiconductor (NMOS), positive channel metal oxide semiconductor (PMOS), bipolar junction transistor (BJT), bipolar CMOS, silicon germanium (SiGe), gallium arsenide (GaAs), etc.

The communication device described in the above embodiments may be the terminal, or may be the SMF, or may be the PCF, or may be the core network, but the scope of the communication device described in this disclosure is not limited to this. The structure of the communication device can be not limited by FIG. 13. The communication device may be a standalone device or a part of a larger device. For example, the communication device may be:
(1) Independent integrated circuit IC, or chip, or chip system or subsystem;
(2) A set of one or more ICs, optionally including storage components for storing data and computer programs;
(3) ASIC, such as modems;
(4) Modules that can be embedded in other devices;
(5) Receiver, terminal, intelligent terminal, cellular phone, wireless device, handheld device, mobile unit, vehicle mounted device, network device, cloud device, artificial intelligence device, etc;
(6) Others and so on.

For the communication device that can be a chip or chip system, please refer to FIG. 13, which is a block diagram of a chip provided in an embodiment of the present disclosure.

As shown in FIG. 13, the chip 1100 includes processors 1101 and interfaces 1103. The number of processors 1101 can be one or more, and the number of interfaces 1103 can be multiple.

For the case where the chip is configured to implement the functions of the terminal in embodiments of the present disclosure:
the interface 1103 is configured to receive code instructions and transmit them to the processor;
the processor 1101 is configured to run the code instructions to implement the assistance operation method described in some of the above embodiments.

For the case where the chip is configured to implement the functions of the SMF in embodiments of the present disclosure:
the interface 1103 is configured to receive code instructions and transmit them to the processor;
the processor 1101 is configured to run the code instructions to implement the assistance operation method described in some of the above embodiments.

For the case where the chip is configured to implement the functions of the PCF in embodiments of the present disclosure:
the interface 1103 is configured to receive code instructions and transmit them to the processor;
the processor 1101 is configured to run the code instructions to implement the assistance operation method described in some of the above embodiments.

Optionally, the chip 1100 also includes a memory 1102 for storing necessary computer programs and data.

Technicians in this field can also understand that various illustrative logical blocks and steps listed in the embodiments of the present disclosure can be implemented through electronic hardware, computer software, or a combination of both. Whether such functionality is implemented through hardware or software depends on the specific application and the design requirements of the entire system. Technicians in this field can use various methods to implement the described functions for each specific application, but such implementation should not be understood as exceeding the scope of protection of the disclosed embodiments.

The present disclosure also provides an assistance operation system. The system includes the communication device as a terminal, the communication device as an SMF, and the communication device as a PCF in the embodiment shown in FIG. 11, or alternatively, the system includes the communication device as a terminal, the communication device as an SMF, and the communication device as a PCF in the embodiment shown in FIG. 12.

The present disclosure also provides a readable storage medium, storing instructions that, when executed by a computer, implement the functions of any of the method embodiments described above.

The present disclosure also provides a computer program product that, when executed by a computer, implements the functions of any of the method embodiments described above.

In the above embodiments, it can be fully or partially implemented through software, hardware, firmware, or any combination thereof. When implemented using software, it can be fully or partially implemented in the form of a computer program product. The computer program product includes one or more computer programs. When loading and executing the computer program on a computer, all or part of the process or function described in embodiments of the present disclosure is generated. The computer may be a general-purpose computer, a specialized computer, a computer network, or other programmable device. The computer program can be stored in a computer-readable storage medium or transmitted from one computer-readable storage medium to another. For example, the computer program can be transmitted from a website site, computer, server, or data center to another website site, computer, server, or data center via wired (such as coaxial cable, fiber optic, digital subscriber line (DSL)) or wireless (such as infrared, wireless, microwave, etc.) means. The computer-readable storage medium can be any available medium that a computer can access, or a data storage device such as a server or data center that integrates one or more available media. The available media can be magnetic media (such as floppy disks, hard disks, magnetic tapes), optical media (such as high-density digital video discs (DVDs)), or semiconductor media (such as solid state disks (SSDs)).

Unless otherwise required by the context, throughout the specification and claims, the term “comprise” and other forms such as the third person singular form “comprises” and the present participle form “comprising” are interpreted as open and inclusive, meaning “including, but not limited to”. In the description of the specification, the terms “some embodiments”, “exemplary embodiments”, etc. are intended to indicate that specific features, structures, materials, or characteristics related to the embodiments or examples are included in at least one embodiment or example disclosed herein. The schematic representation of the above terms does not necessarily refer to the same embodiment or example. In addition, the specific features, structures, materials, or characteristics described may be included in any appropriate manner in any one or more embodiments or examples.

Those skilled in the art can understand that the first, second, and other numerical numbers mentioned in this disclosure are only for the convenience of description and are not intended to limit the scope of the disclosed embodiments, but also indicate the order of occurrence.

“At least one” in the present disclosure can also be described as one or more, and “multiple” \can be two, three, four, or more, without limitation in this disclosure. In embodiments of the present disclosure, for a type of technical feature, the technical features in the type of technical feature are distinguished by “first”, “second”, “third”, “A”, “B”, “C”, and “D”, etc. The technical features described by “first”, “second”, “third”, “A”, “B”, “C”, and “D” have no order of priority or size.

Ordinary technical personnel in this field can realize that the units and algorithm steps described in the embodiments of the present disclosure can be implemented through electronic hardware, or a combination of computer software and electronic hardware. Whether these functions are executed in hardware or software depends on the specific application and design constraints of the technical solution. Professional technicians can use different methods to achieve the described functionality for each specific application, but such implementation should not be considered beyond the scope of this disclosure.

Technicians in the relevant field can clearly understand that, for the convenience and conciseness of description, the specific working process of the system, device, and unit described above can refer to the corresponding process in the aforementioned method embodiments, which will not be repeated here.

The above is only a specific implementation of the present disclosure, but the scope of protection of the present disclosure is not limited to this. Any skilled person familiar with the technical field can easily think of changes or replacements within the technical scope disclosed in the present disclosure, which should be included in the scope of protection of the present disclosure. Therefore, the scope of protection of this disclosure should be based on the scope of protection of the claims.

1. An assistance operation method, performed by a terminal, comprising:
generating terminal status assistance operation information according to status information of the terminal; and
sending the terminal status assistance operation information to a core network through an access network device.

2. The method of claim 1, wherein sending the terminal status assistance operation information to the core network through the access network device comprises:
sending a non-access stratum (NAS) message to the core network through the access network device, wherein the NAS message comprises the terminal status assistance operation information; or
sending a next generation application protocol (NGAP) message to the core network through the access network device, wherein the NGAP message comprises the terminal status assistance operation information.

3. The method of claim 1, wherein sending the terminal status assistance operation information to the core network through the access network device comprises:
sending the terminal status assistance operation information to an access and mobility management function (AMF) through the access network device, and sending the terminal status assistance operation information to a session management function (SMF) through the AMF.

4. (canceled)

5. The method of claim 1, wherein the status information of the terminal comprises at least one of:
a battery level;
a battery life;
a powered mode;
an overheating status; or
a load status.

6. The method of claim 1, wherein the terminal status assistance operation information is configured to indicate at least one of:
an assistance operation mode;
an operation indicator corresponding to the assistance operation mode;
a threshold value;
an assistance operation mode functionality;
a priority; or
an importance.

7. The method of claim 6, wherein the assistance operation mode is configured to indicate the assistance operation mode can be applied to matching traffic and associated parameters.

8. The method of claim 6, wherein the operation indicator corresponding to the assistance operation mode comprises at least one of:
indicating autonomous operation in a case where the assistance operation mode is set to load balancing;
indicating terminal-assistance operation in a case where the assistance operation mode is set to load balancing;
indicating autonomous operation in a case where the assistance operation mode is set to power consumption;
indicating terminal-assistance operation in a case where the assistance operation mode is set to power consumption;
indicating autonomous operation in a case where the assistance operation mode is set to protocol data unit (PDU) set based quality of service (QoS) handling; or
indicating terminal-assistance operation in a case where the assistance operation mode is set to PDU set based QoS handling.

9. The method of claim 6, wherein the threshold value comprises at least one of:
a maximum round trip time (RTT);
a maximum packet loss rate;
a guaranteed flow bit rate (GFBR); or
an aggregate maximum bit rate (AMBR).

10. The method of claim 6, wherein the assistance operation mode functionality comprises at least one of:
applying a load balancing functionality to matching traffic;
cancelling applying a load balancing functionality to matching traffic;
applying a power consumption balancing functionality to matching traffic;
cancelling applying a power consumption balancing functionality to matching traffic;
applying a PDU set based QoS handling functionality to matching traffic; or
cancelling applying a PDU set based QoS handling functionality to matching traffic.

11. The method of claim 6, wherein the priority is a priority of applying a QoS rule to matching traffic;
wherein the importance is an importance of applying a QoS rule to matching traffic.

12. (canceled)

13. An assistance operation method, performed by an SMF, comprising:
receiving terminal status assistance operation information; and
sending the terminal status assistance operation information to a policy control function (PCF).

14. The method of claim 13, further comprising:
receiving a policy and charging control (PCC) rule sent by the PCF, wherein the PCC rule is generated by the PCF according to the terminal status assistance operation information sent by the SMF;
generating a policy related rule according to the PCC rule; and
sending the policy related rule from an access network device to a terminal through an AMF.

15. The method of claim 13, wherein sending the terminal status assistance operation information to the PCF comprises:
in response to receiving a subscription request for the terminal status assistance operation information and satisfying a reporting condition, sending the terminal status assistance operation information to the PCF; or
sending the terminal status assistance operation information to the PCF according to subscription information.

16.-23. (canceled)

24. The method of claim 14, wherein the policy related rule comprises at least one of:
updating quality of service (QoS) parameters of business session of the terminal;
updating QoS parameters of business traffic of the terminal;
deciding to perform protocol data unit (PDU) set based QoS handling;
deciding to cancel performing PDU set based QoS handling;
deciding to select different QoS profiles and perform different QoS levels based on priorities of PDU sets;
deciding to select different QoS profiles and perform different QoS levels based on importance of PDU sets;
deciding to select different QoS profiles and perform different QoS levels based on priorities of PDU set groups;
deciding to select different QoS profiles and perform different QoS levels based on importance of PDU set groups;
deciding to cancel selecting different QoS profiles and perform different QoS levels based on priorities of PDU sets;
deciding to cancel selecting different QoS profiles and perform different QoS levels based on importance of PDU sets;
deciding to cancel selecting different QoS profiles and performing different QoS levels based on priorities of PDU set groups; or
deciding to cancel selecting different QoS profiles and performing different QoS levels based on importance of PDU set groups.

25. An assistance operation method, performed by a PCF, comprising:
receiving terminal status assistance operation information sent by an SMF; and
generating a PCC rule according to the terminal status assistance operation information.

26. The method of claim 25, further comprising:
sending the PCC rule to the SMF.

27. The method of claim 25, further comprising:
sending a subscription request for the terminal status assistance operation information to the SMF.

28.-40. (canceled)

41. A terminal, comprising:
a processor; and
a memory, configured to store instructions executable by the processor,
wherein the processor is configured to implement the method of claim 1 by running the instructions stored in the memory.

42. An SMF, comprising:
a processor; and
a memory, configured to store instructions executable by the processor,
wherein the processor is configured to implement the method of claim 13 by running the instructions stored in the memory.

43. A PCF, comprising:
a processor; and
a memory, configured to store instructions executable by the processor,
wherein the processor is configured to implement the method of claim 25 by running the instructions stored in the memory.

44.-46. (canceled)
